(19) United States
(12) Patent Application Publication
(10) Pub. No.: US 2015/0081366 A1
(43) Pub. Date: Mar. 19, 2015

(54) Computer-Based System and Method for Flexible Project Management

(71) Applicants: Alexander L. Fernandez, Las Vegas, NV (US); Daniel Owen Flower, Kuala Lumpur (MY); Stefan Baier, Kuala Lumpur (MY); Hector R. Fernandez, San Francisco, CA (US)

(72) Inventors: Alexander L. Fernandez, Las Vegas, NV (US); Daniel Owen Flower, Kuala Lumpur (MY); Stefan Baier, Kuala Lumpur (MY); Hector R. Fernandez, San Francisco, CA (US)

(21) Appl. No.: 14/488,763

(22) Filed: Sep. 17, 2014

Related U.S. Application Data
(60) Provisional application No. 61/878,985, filed on Sep. 17, 2013.
(60) Provisional application No. 61/886,942, filed on Oct. 4, 2013.
(60) Provisional application No. 61/915,898, filed on Dec. 13, 2013.

(51) Int. Cl. G06Q 10/06

(52) U.S. Cl. CPC G06Q 10/06313; G06Q 10/063114
USPC 705/7.15

(57) ABSTRACT

Computer-implemented system and method for improved management of projects that result in deliverables, such as deliverables to a client or customer. Resources such as staff members and time needed to generate the deliverables are scheduled according to the environment in which they exist. The environment can include the particular asset list the deliverables are part of, the individual staff or teams of staff that are available for assignment or have been assigned to complete a particular list, and the like. Teams may specify a priority of any task. When a deliverable is entered into the system its component tasks behave as a workflow comprising data objects. The data objects are treated in accordance with team-specific attributes. Schedules are revised automatically as tasks are advanced or completed, or as new tasks are added taking into account task priorities and team attributes.

### CROSS REFERENCE TO RELATED APPLICATION

This application claims priority to U.S. Provisional Application Ser. No. 61/878,985, filed Sep. 17, 2013, entitled “Computer-Based System and Method for Flexible Project Management,” U.S. Provisional Application Ser. No. 61/886,942, filed Oct. 4, 2013, entitled “Computer-Based System and Method for Flexible Project Management,” and U.S. Provisional Application Ser. No. 61/915,898, filed Dec. 13, 2013, entitled “Computer-Based System and Method for Flexible Project Management,” the disclosures of which are incorporated by reference herein as is set forth in their entirety.

### BACKGROUND OF THE INVENTION

1. Field of the Invention

The present invention is directed to the management of projects being worked on by teams, and, more particularly, to a system and method for flexible project management.

2. Description of the Background

In prior art computer-based project management platforms, a project deliverable is created to which resources are directly assigned and scheduled. The schedule is then narrowly followed, or manual adjustments by staff are required.

In addition, project timelines, such as may be provided in the aforementioned schedule, generally are of two types. One type shows all project tasks, which can result in data overload. The other type shows only the tasks assigned to an individual, which does not provide context to the individual and may result in inefficiencies.

Furthermore, internal data, such as time spent on tasks, may be used to generate updates for external parties, such as clients. However, in other instances, internal conditions leading to revised schedules may not be accounted for to the clients, leading to unrealistic expectations based on incomplete information.

### SUMMARY OF THE INVENTION

A computer-implemented system and method for improved management of projects that result in deliverables, such as deliverables to a client or customer. Resources such as staff members and time needed to generate the deliverables are scheduled according to the environment in which they exist. The environment can include the particular asset list the deliverables are part of, the individual staff or teams of staff that are available for assignment or have been assigned to complete a particular list, and the like.

Teams may specify a priority of any task. When a deliverable is entered into the system its component tasks and/or priorities behave as a workflow comprising data objects. The data objects are treated in accordance with team-specific attributes. Schedules are revised automatically as tasks are advanced or completed, or as new tasks are added, taking into account task priorities and team attributes.

It is to be understood that both the foregoing general description and the following detailed description are exemplary and explanatory and are intended to provide further explanation of the invention as claimed.

### BRIEF DESCRIPTION OF THE FIGURES

The drawings illustrate exemplary embodiments and/or aspects of the invention and, together with the description, serve to explain the principles of the invention, the scope of which is determined by the claims.

In the drawings, like numerals represent like aspects, and:

FIG. 1 is a block diagram of an exemplary computing device that may be used in the disclosed systems and methods.

FIG. 2 is a block diagram showing a plurality of networked user terminals and a server that may be used in the herein disclosed systems and methods.

FIG. 3 illustrates the separation of system functionality for internal users and external users in accordance with the herein disclosed systems and methods.

FIG. 4 illustrates exemplary aspects of the apparatus of FIG. 3.

FIGS. 5-32 show screenshots of illustrative embodiments in accordance with the herein disclosed systems and methods.

### DETAILED DESCRIPTION OF THE INVENTION

It is to be understood that the figures and descriptions provided herein may have been simplified to illustrate elements that are relevant for a clear understanding of the present invention, while eliminating, for the purpose of clarity, other elements found in typical systems and methods in the prior art. Those of ordinary skill in the art may recognize that other elements and/or steps may be desirable and/or necessary to implement the devices, systems, and methods described herein. However, because such elements and steps are well known in the art, and because they do not facilitate a better understanding of the present invention, a discussion of such elements and steps may not be provided herein. The present disclosure is deemed to inherently include all such elements, variations, and modifications to the disclosed elements and methods that would be known to those of ordinary skill in the pertinent arts.

The herein disclosed systems and methods provide for improved management of projects that result in deliverables, such as deliverables to a client or customer. Such projects may include, by way of non-limiting example, production of entertainment, financial and investment, accounting, auditing, legal, government contracts, and the like. Resources such as staff members and time needed to generate the deliverables are scheduled according to the environment in which they exist. The environment can include the particular asset list the deliverables are part of, the individual staff or teams of staff that are available for assignment or have been assigned to complete a particular list, and the like. The disclosed systems and methods support each team in determining how best to respond to a particular task, group of tasks, or project phase within its own environment. Each team may specify a preferred order in which any task/phase should be processed compared to others. Thus, when a deliverable to be created is entered into the system, for example as part of an asset list, its component tasks behave as a workflow comprising data objects. The data objects are then treated in accordance with team attributes specific to that team. Tasks are scheduled automatically or recommended by the system, taking into account task priorities specific to the project, and taking into account team attributes, settings for approvals, and automation of certain task phases.

Use of the system results in workflows that emerge naturally and automatically for any configuration of tasks, as their respective priorities and resource requirements are set on a team level. Consequently, project scheduling does not use templates comprising predetermined static workflows for deliverables, but is instead determined dynamically by the system in accordance with the attributes and environment of any given team. This leads to uniform higher level templates, but with no higher level workflows set up, because team level processes ensure the tasks and project phases are handled efficiently on the lower levels.

Illustratively, a user such as a staff member that is participating in advancing a project may be provided with detailed views showing tasks, hours, and resources that pertain to that user, and may include contextual information to clarify the relation of the user's tasks to other relevant project related information. Conversely, a user that is interested in the progress of the entire project, such as a client that is waiting for a deliverable work product of the project, may be provided with normalized views in which the progress of all relevant tasks are combined, normalized, and converted into an indicator of the progress of the project as a whole, or of specific deliverables and work products of interest, in a manner calculated to result in realistic expectations based on actual progress by abstracting internal details.

In exemplary aspects, communication between project participants may be facilitated, including feedback, approval, rejection, and acceptance, for example, based on deliverables. In an embodiment, a plurality of time-based aspects may be viewable, such as bid hours (that is, an estimate of the person-hours required for a project, that may be used to bid on the project); actual hours (that is, person-hours actually expended on the project); and a forecast of the time remaining by the calendar to complete the project.

Cost reporting may be tracked, forecasted, and viewed based on individual tasks. Profitability analysis may be based on inputs that account for all resources already used and estimated to be required to complete the project. Project tasks may be ordered based on their respective priority, such as for scheduling and resource management. Efficiency may be determined by comparing the estimated time and resources needed to complete tasks to what has been logged and expended against those tasks. Updates can be provided periodically, such as at the end of every day, or in real time and updated with each new input of relevant information. In an exemplary aspect, assets may be assigned to a group of project participants, and the group's tasks may take on attributes of the group.

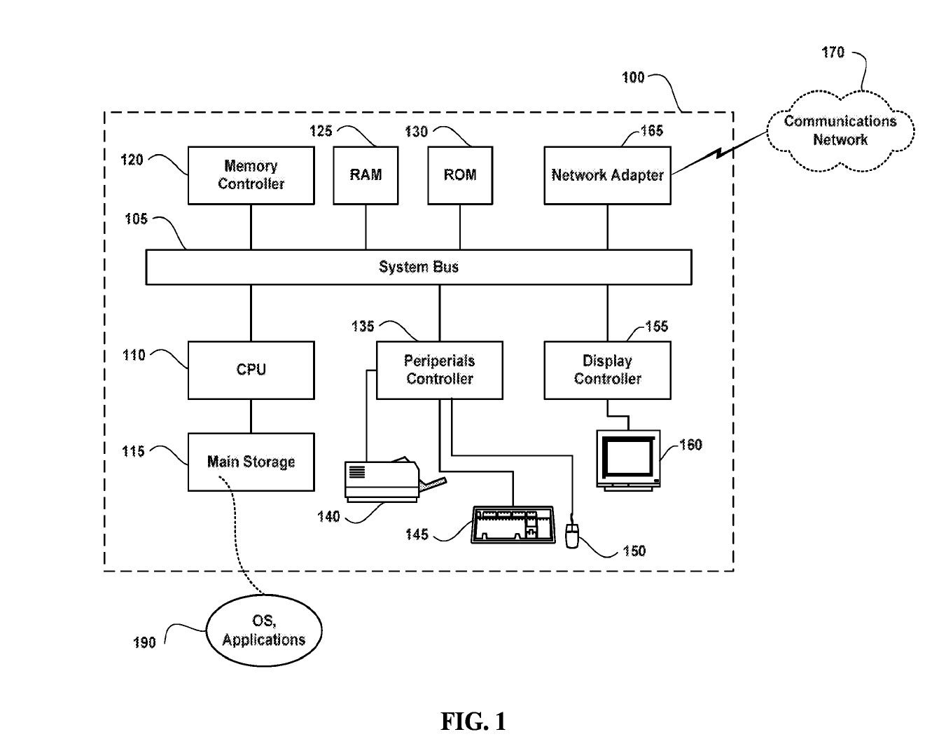

FIG. 1 depicts an exemplary computing system 100 that may be used in implementing the herein described apparatus, systems, and methods. Computing system 100 is capable of executing software, such as by providing an operating system (OS) and a variety of executable computing applications, or “apps,” 190. The operation of exemplary computing system 100 is controlled primarily by computer readable instructions, such as instructions stored in a computer readable main storage device 115, such as hard disk drive (HDD), an optical disk (not shown) such as a CD or DVD, solid state drive such as a USB “thumb drive” (not shown), or the like. Such instructions may be executed within central processing unit (CPU) 110 to cause computing system 100 to perform operations. In many known computer servers, workstations, personal computers, mobile devices, and the like, CPU 110 is implemented in an integrated circuit called a microprocessor.

It is appreciated that, although exemplary computing system 100 is shown to comprise a single CPU 110, such description is merely illustrative as computing system 100 may comprise a plurality of CPUs 110. Additionally, computing system 100 may exploit the resources of remote CPUs (not shown), for example, through communications network 170 or some other data communication means.

In operation, CPU 110 fetches, decodes, and executes instructions from a computer readable storage medium such as storage device 115. Information, such as computer instructions and other computer readable data, is transferred between components of computing system 100 via the system's main data-transfer path 105. The main data-transfer path may use system bus architecture, although other computer architectures (not shown) can be used, such as architectures using serializers and deserializers and crossbar switches to communicate data between devices over serial communication paths.

Memory devices coupled to system bus 105 can include random access memory (RAM) 125 and read only memory (ROM) 130. Such memories include circuitry that allows information to be stored and retrieved. Data stored in RAM 125 can be read and readily changed by CPU 110 or other hardware devices, whereas data stored ROM 130 generally cannot. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes.

In addition, computing system 100 may contain peripherals controller 135 responsible for communicating instructions using a peripheral bus from CPU 110 to peripherals, such as printer 140, keyboard 145, and mouse 150. An example of a peripheral bus is the Universal Serial Bus (USB) bus.

Display 160, which is controlled by display controller 155, can be used to display visual output generated by computing system 100. Such visual output may include text, graphics, animated graphics, and/or video, for example. Display 160 may be an LCD-based display for example, and may include touch sensitive input capability. Display controller 155 includes electronic components required to generate a video signal that is sent to display 160.

Further, computing system 100 may contain network adapter 165 which may be used to couple computing system 100 to an external communication network 170, which may include or provide access to the Internet, and hence which may provide for entering, accessing, and analyzing the data discussed herein. Communications network 170 may provide a user of computing system 100 with means of communicating and transferring software and information electronically. The network interface may be wired, such as an ethernet or cable connection to a wired network, or may be wireless, such as an air interface to a WiFi or cellular network. Additionally, communications network 170 may provide for distributed processing involving a plurality of computers and the sharing of workloads or cooperative efforts in performing tasks. It is appreciated that the network connections shown are exemplary and other means of establishing communications links between computing system 100 and remote users may be used.

It is appreciated that exemplary computing system 100 is merely illustrative of an exemplary computing environment in which the herein described systems and methods may operate and does not limit the herein disclosed systems and methods. Rather, computing environments having differing components and configurations may be used. That is to say, the inventive concepts described herein may be implemented in various computing environments using various components and configurations.

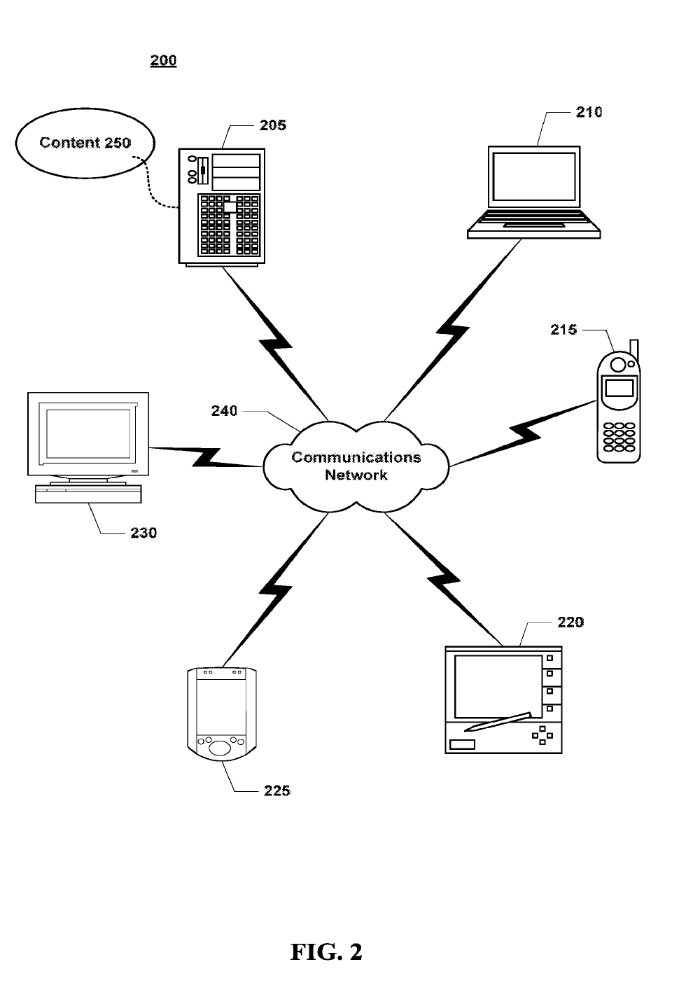

Computing system 100 may be deployed in networked computing environment 200 such as that shown in FIG. 2. In general, aspects of the above description for computing system 100 may be applied to server, client, and peer computers and user terminals deployed in a networked environment as shown. For example, server 205, laptop computer 210, mobile telephone 215, tablet computer 220, and smart phone 225, and personal computer (PC) 230 may each include and/or share some or all of the apparatus shown in FIG. 1. FIG. 2 thus illustrates an exemplary networked computing environment 200, including a server in communication with client computing and/or communicating devices via a communications network, in which the herein described apparatus and methods may be employed.

As shown in FIG. 2, server 205 may be interconnected via a communications network 240 (which may include any of, or any combination of, a fixed-wire or wireless LAN, WAN, intranet, extranet, peer-to-peer network, virtual private network, the Internet, or other communications network such as POTS, ISDN, VoIP, PSTN, etc.) with a number of client computing/communication devices such as laptop computer 210, wireless mobile telephone 215, tablet computer 220, smart phone 225, PC 230, and/or other communication enabled devices (not shown). Server 205 can comprise dedicated servers operable to process and communicate data such as digital content 250 to and from client devices 210, 215, 220, 225, 230, etc. using any of a number of known protocols, such as hypertext transfer protocol (HTTP), file transfer protocol (FTP), or the like. Additionally, networked computing environment 200 can utilize various data security protocols such as secured socket layer (SSL), pretty good privacy (PGP), virtual private network (VPN) security, or the like. Each client device 210, 215, 220, 225, 230, etc. can be equipped with an operating system operable to support one or more computing and/or communication applications, such as a web browser (not shown), email (not shown), and independently developed applications, to interact with server 205.

The server 205 may thus deliver and/or or communicate via applications specifically designed for the client devices. Client devices may any of a plurality of operating systems. Such operating systems may include, for example, Windows, Android, Apple iOS, Symbian, RIM Blackberry OS, Palm webOS, and Linux. Illustratively, mobile operating systems and applications may be programmed in any appropriate programming language, such as C, C++, Java, and/or .NET, for example.

The herein disclosed systems and methods provide a computer-based platform for project management, including server and client aspects as described, in connection with FIGS. 1 and 2. That is, the systems and methods provided herein may be both locally and remotely accessible, with unique aspects available to a local or remote user based on permissions of that particular user, i.e., general permissions, administrative permissions, client permissions, team A versus team B permissions, legal versus engineering permissions, and so on. Such accessibility may be via an Internet, intranet, and/or extranet access, and/or via a mobile access based on one or more partially thin-client mobile apps, by way of non-limiting example.

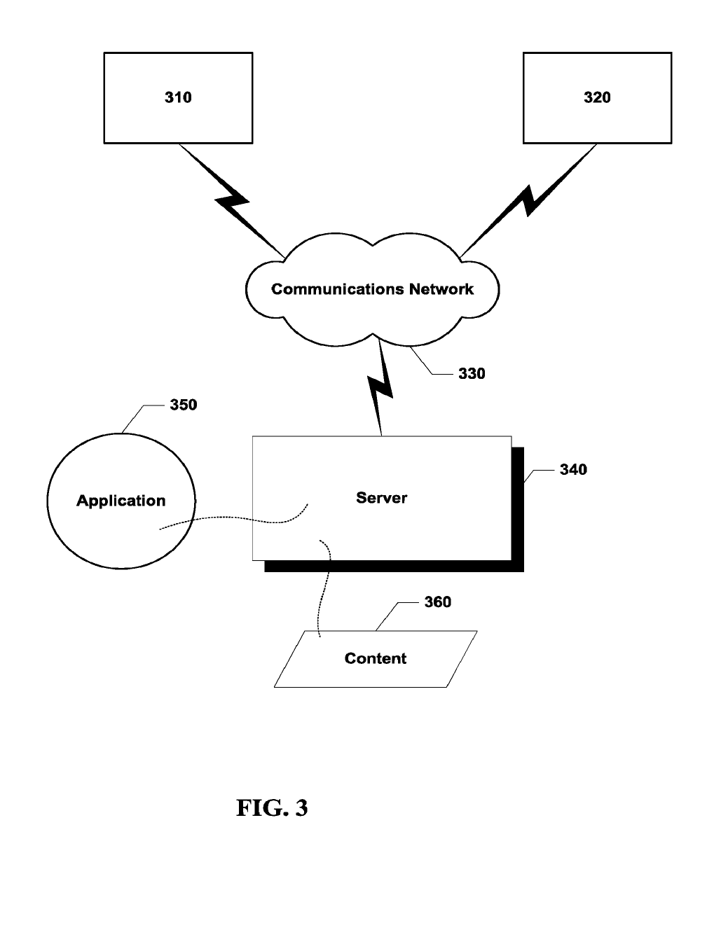

As is illustrated in the exemplary embodiment illustrated in FIG. 3, the system allows for separation of users by internal users and external users. That is, internal users are those that contribute to accomplishing a project, in particular by generating project deliverables. External users may be clients for whom the project is being advanced, and who will be receiving the deliverables when complete. As shown, user terminal 310 may be used by an internal user, and user terminal 320 by an external user, to communicate via communications network 330 with server 340. Server 340 comprises a project management application 350, and project content 360 such as project information that may be stored in a database, for example. In one aspect, project information may be obtained from internal users and abstracted for presentation to external users, as will be described.

In exemplary aspects, the system may be used to generate a work schedule based on attributes of available staff, such as a team of software developers or artists working on computer generated graphics for example. Thereafter, the system may analyze the efficiency of a schedule, either prospectively in connection with a future schedule, or retroactively based on historical information. In an embodiment, the effect of excessive “gaps” in work flow can incur a gap penalty. That is, the system may be configured to favor working on tasks continuously or with minimal interruptions. Further, if there is an interruption, the system may be configured to favor fewer but longer interruptions rather than more numerous but shorter interruptions. Thereby, the system may reduce the amount of fragmentation of tasks, allowing task—advancing momentum to be maintained. In particular, the system can recognize that gaps in any task may translate to a loss of momentum that is difficult or impossible to account for in the prior art. In an embodiment, the system may generate a fragmentation index that takes into account the fragmentation of tasks, and operate to influence the scheduling of tasks to minimize the fragmentation index.

Illustratively, the system may assign a maximum allowable fragmentation index to an individual staff member who uses task reporting or task tracking reporting daily. The system may evaluate the fragmentation index of the tasks being worked on by this staff member, and may determine, for example, that this staff member is undesirably stretched between different tasks as indicated by frequent and short periods of time devoted to a plurality of tasks. Based on this determination, the system may generate alerts suggesting that the staff member's time be scheduled differently, or may automatically generate a less fragmented schedule. Prospectively, the system may determine that an upcoming day is overly filled with meetings resulting in excessive gaps and interruptions to a staff member's work flow. Based on that, the system may operate to recommend to a manager, or may automatically generate, a schedule containing fewer or shorter meetings, or simply a different, less disruptive schedule.

In an embodiment, the system is focused around domains of responsibilities, which are organized as workspaces that help stakeholders by displaying updates relevant to their respective individual position or role. Thereby, the system provides for situational awareness based on a user's scope of responsibilities in connection with aspects of the projects they are involved in.

In contrast, prior art systems tend to rely on one or both of two approaches to displaying project task data. In one approach, prior art systems show everything related to all tasks in a project, typically in a Gantt chart, which creates data overload. A Gantt chart is a type of bar chart that illustrates a project schedule. Gantt charts generally include start and finish dates of project tasks, and of a project as a whole, and may also show dependency relationships between activities. Alternatively, in the prior art tasks may be filtered to provide a view of only tasks in which a particular user is personally associated. Such a view does not provide context, and may lead to inefficiencies arising from a lack of appreciation of how one person's work relates to others engaged in related work.

In contrast, the present system focuses instead on roles and corresponding domains of interest, which may include filters in several steps. Thereby, users are provided with a great amount of flexibility in setting up a project to ensure they are apprised of information for the domain relevant to them. In an embodiment, this is realized by establishing one or more standardized contexts, which are consistent across an enterprise. For example, project codenames and activities may be defined in a central list that determines where tasks and conversations associated with these tasks will be viewable. In an embodiment, tasks may be tagged with predetermined tags or sets of tags, and filters may operate on the tags to provide views of information having a scope determined by the tags and by user roles. In a presently preferred embodiment, tasks may be characterized as belonging in one or both of a production or an operations domain. Tasks so identified may be organized by the system into respective production and operations streams. Further, filters may be applied to such streams based on tags associated with individual tasks, to provide respective stakeholders views of project information having a scope appropriate to the role of the stakeholder.

In an exemplary operation, a task may be created and associated with an operational activity, a project activity, or both. The task may subsequently be filtered either into an operations “stream” (i.e., workflow), or a project stream. Access to streams may be limited according to the role of a user requesting access to streams, or limited access to other, unrelated streams may be provided, or access may be limited to streams that are directly or closely related to the requester. This approach provides a comfortable workspace to users in a company based on their respective roles. In an embodiment, an initial default filter may be applied responsive to a request for stream information, based on the role of the requester, such as for production or operational managers.

This role-based workspace approach may reduce noise in the system, for example, by avoiding duplicative and confusingly similar names, and may mitigate general oversights caused by excessive tagging and associating people with project elements in an excessive abundance of caution.

The role-based workspace also enforces a focus on the roles of project stakeholders, and provides an institutionally relevant stream of activity that may, for example, include history and context to a new individual joining the company, or joining a project mid-stream. That is because streams and filters include distinctions such as production versus operations, projects versus, activities, and the like, and do not depend excessively on individuals who may leave or change roles.

Illustratively, a task which is tagged with both an operations and a project tag would show up in both streams as a transversal task concerning both aspects of a project.

In an embodiment, the system provides an interface with which a user enters information of a project, which is defined as having deliverables, and a deliverable list may be generated therefrom. Further, each deliverable is defined as comprising one or more tasks, and information of the tasks may be entered via the user interface. Tasks are thereby easily associated with a specific deliverable of a specific project. A new task may be added to a deliverable by searching for the name of the deliverable and using the interface to add the new task. The system may then automatically associate the task to the correct project, and ensure it shows up in the correct production stream. Likewise, a task associated with an operations activity will show up in an operations stream. Thus, elements of projects and operations are treated as data objects which are inserted into a corresponding stream, and can be viewed in context in the stream, and may be commented on by system users.

The previously mentioned deliverable list may be used to provide an understanding of progress on a project and whether or not the expectations and estimates originally set have been met. Different views may be provided to users based on their roles, which in an embodiment may include both internal users and external users. Internal users may include, for example, staff members and managers, whereas external user may include clients and customers, for example. Role-based deliverable lists allows for tracking, adjusting, and reporting of time and resources expended on project deliverables in different, but related, ways to both internal and external users. For example, a projected expenditure of time to complete a project deliverable may have been agreed upon with the client. However, times agreed on internally may be different. Furthermore, the time actually spent in advancing the project deliverable may not meet projections. Using different approaches to reporting project progress for internal versus external users gives each user information in a form most important to that user. For example, an internal user may be able to make better informed decisions on expenditures and skill of staff used based on deviations from projections. In contrast, an external user most likely just wants to know how far advanced a project or a deliverable is toward completion. Accordingly, different approaches may be employed to provide different users with information in a form that may be predetermined based on their respective needs, even though such information may be based on the same inputs.

In an embodiment, the system provides access to project data of various kinds based on the role or status of the user. For example, the system may recognize that certain data may be shared with clients, whereas other data is only for internal review. In an embodiment, only asset-level information (i.e., information of project deliverables) may be shared with clients, while task level information is reserved for internal use only. However, a normalization process may be used to convert internal data for viewing by external users, thereby providing meaningful updates to the external users (such as clients).

Illustratively, an asset may have been agreed with a client to require ten hours of work. However, internally it may have been estimated to actually require 12 hours to complete. Thus, internally the system will display 50% progress after six hours has been spent on it (6/12=50%). Or, it may be that the original internal estimate was ten hours but after six hours the asset is only half done, causing the internal estimate to be revised to 12 hours. It may be undesirable to charge the client for the extra two hours, which may be due to internal inefficiency. Moreover, if it had been reported to the client that six hours of progress had been made on a ten hour project, the client would understand, erroneously. that the project was 60% completed, resulting in distorted client expectations. Therefore, the system normalizes, or converts, the progress toward completion as determined internally, to a value that is scaled in accordance with the original agreement with the client. Here, the six hours spent on the project whose revised estimate to completion is 12 hours, may be reported to the client as 50% completed, or may be converted to the scale of the ten hour time estimate agreed upon, which is 5 hours completed.

The result of using the system is that staff working on a project can report hours actually worked, and the staff person or manager can revise the estimate for internal use of how many hours will be needed to complete the project, and the system automatically uses that information to report to the client, but first normalized to the client's agreed hours. Thereby for example, the system allows fair use of trainees (slower than client agreed), or provides fair benefit for efficiency gains (i.e., time saved internally but still charged fully). Thus, clients can see progress in individual assets in a deliverable list that is always up to date.

In an embodiment, assets such as project deliverables may be viewable by an external user such as a client. Accordingly, assets may vary by project type. For example, in a production of entertainment context, assets may comprise individual images, or frames, or a character, such as an animated character. Correspondingly, in such a context, tasks may contribute to completion of one or more assets. Likewise, the deliverables may comprise a set or sets of the assets in an asset list.

Internal users may upload completed deliverable files to a server and tag or mark the uploaded files to be visible externally. Such files may be the result of a plurality of completed tasks, for may have been worked on by more than one staff member. Uploaded files so marked will be accessible to the client, for example, as a group of images comprised in one deliverable asset, if the original tasks were identified as port of the same project deliverable.

In an embodiment, regular updates by staff may be included in an automatically updated real time schedule (RTS), which may be presented to users as a timeline. The RTS timeline is different from the Gantt charts common in the prior art, which include start and end dates, and rely on analyzing which tasks are still incomplete, how many hours are estimated for those tasks, which individuals they are assigned to.

In contrast, in an embodiment tasks are assigned respective priority ratings, which are used by the system to assist in the ordering of the tasks. Tasks that have not been completed are used to generate a full schedule for the future, based at least partially on respective task priorities and the hours estimated to be needed to complete each task. But, unlike generating a Gantt chart, the schedule may be created without entering start and end dates for the tasks, which typically are departed from shortly after having been entered. In an embodiment, avoiding gaps is taken into account during task scheduling.

The auto-scheduling by the system can readjust timelines as needed, automatically filling gaps arising from changes in timelines with subsequent tasks, for example, in priority order. Correspondingly, if a new task is added, such as by a supervisor in a schedule that is already tightly packed, it will be positioned in production timelines according to its priority setting, and other tasks will be reordered and moved around it accordingly. In an embodiment, the system may reassign tasks to levelize workloads of staff members working on a project, or may recommend to a manager to reassign tasks. Such automatic reassignment or recommendation may be based on an analysis of staff member efficiencies, known skill sets, and the like. Further, reassignments may be made or recommended based on known or unexpected interruptions in a staff member's schedule, such as due to a looming vacation, or an unexpected health issue from an accident or disease, for example.

In an embodiment, staff may log hours spent on their respective tasks manually, for example at the end of every day. Alternatively, a system timer may be used to keep track of time spent on a task and log the time spent automatically. When time is logged, the task time still left over is automatically reduced by the hours logged against the task. This provides flexibility regarding which tasks are worked on, and allows staff to work on multiple assignments, automatically updating the schedule. Thus, the RTS is both a planning tool, and a tracking tool, receiving ongoing or periodic updates in any given production and adjusting schedules accordingly.

In an embodiment, each day's task-related activities may be analyzed after hours are logged. Analyzing the tasks worked on and the hours logged may provide a highly granular view of resources spent, and can tease out relationships such as velocity versus accuracy. In particular, time spent per day on any given project may be determined, and billings may be automatically calculated based on the hourly rate of the respective staff members who logged the hours.

Thus, the system does not use the same automation workflows as are used in prior art management systems. In prior art systems, a project deliverable is created to which resources are assigned directly and scheduled. The schedule is then narrowly followed, or manual adjustments by staff are required.

In contrast, in the herein disclosed systems and methods, resources such as time needed to generate deliverables are scheduled according to the environment in which they exist. The environment can include the particular asset list they are part of, the individual staff or teams of staff which are available for assignment or have been assigned to that particular list, and the like. Each team can determine how to respond to a particular task, group of tasks, or project phase within its own environment. Each team may specify a preferred order in which any task/phase should be processed compared to others. Thus, when a deliverable is entered into the system, for example as part of an asset list, its component tasks behave as a workflow comprising data objects that will be treated in accordance with team attributes that are unique to that team. Tasks are scheduled automatically or recommended, taking into account task priorities specific to the project and taking into account team attributes, settings for approvals, and automation of task phases followed through accordingly.

Use of the system results in workflows that emerge automatically for any configuration of tasks as their order and behaviors are set on a static team level. Consequently, templates of assets do not require static workflows, but will be determined by the system in accordance with any given team environment. This leads to uniform higher level templates, and no higher level workflows set up, as team level processes ensure the phases are handled appropriately on the lower levels.

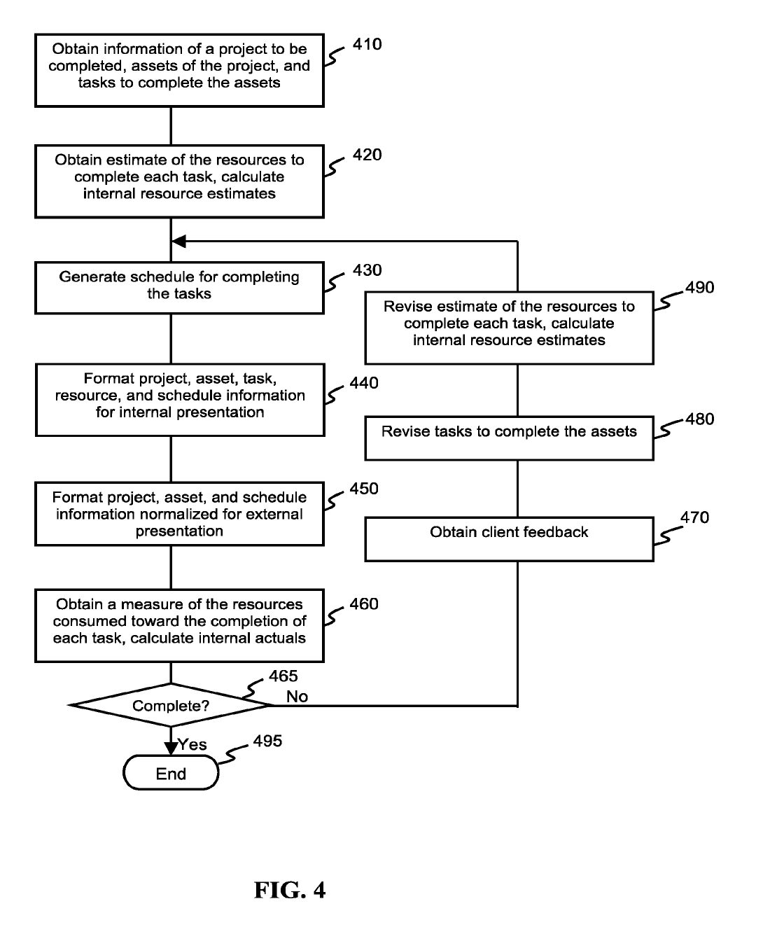

FIG. 4 shows a method of an illustrative implementation. As shown, the method starts by the system obtaining information of a project to be completed, assets of the project, and tasks to complete the assets, 410. The system also obtains an estimate of the resources to complete each task, and calculates internal resource estimates for the tasks, 420. The system obtains a measure of the resources consumed toward the completion of each task, and calculates actual totals of resources consumed on project assets and the project as a whole, 430. A schedule for completing the tasks is obtained or generated automatically, 440. Information pertaining to the project, assets, tasks, resources, and schedule information are formatted for internal presentation, 450. In addition, project, asset, and schedule information are normalized to be reflective of values agreed upon with an external party and formatted for external presentation to that party.

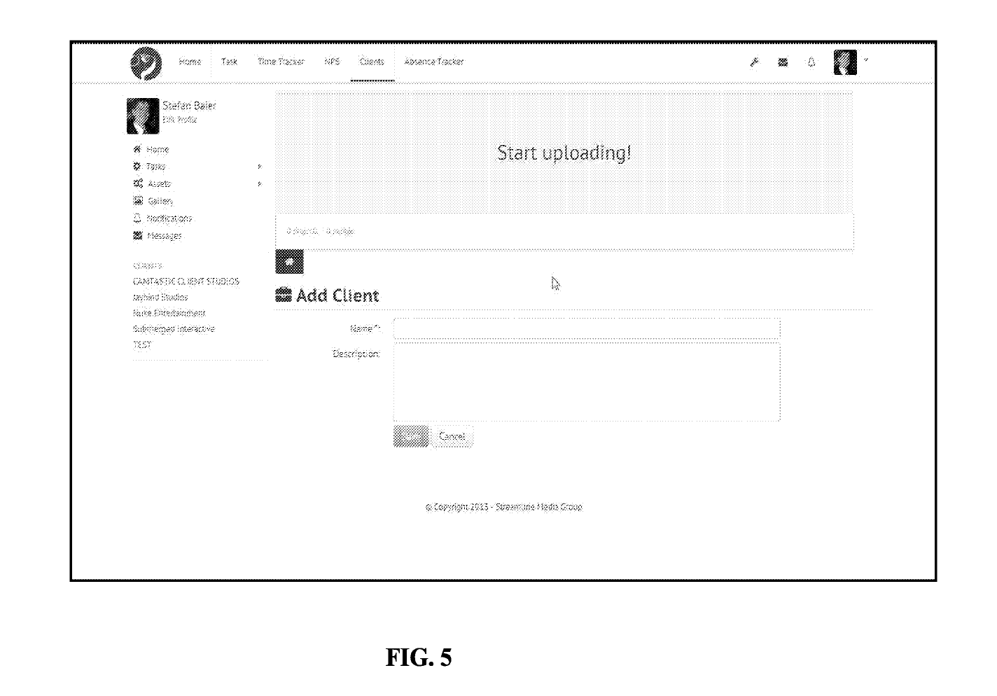

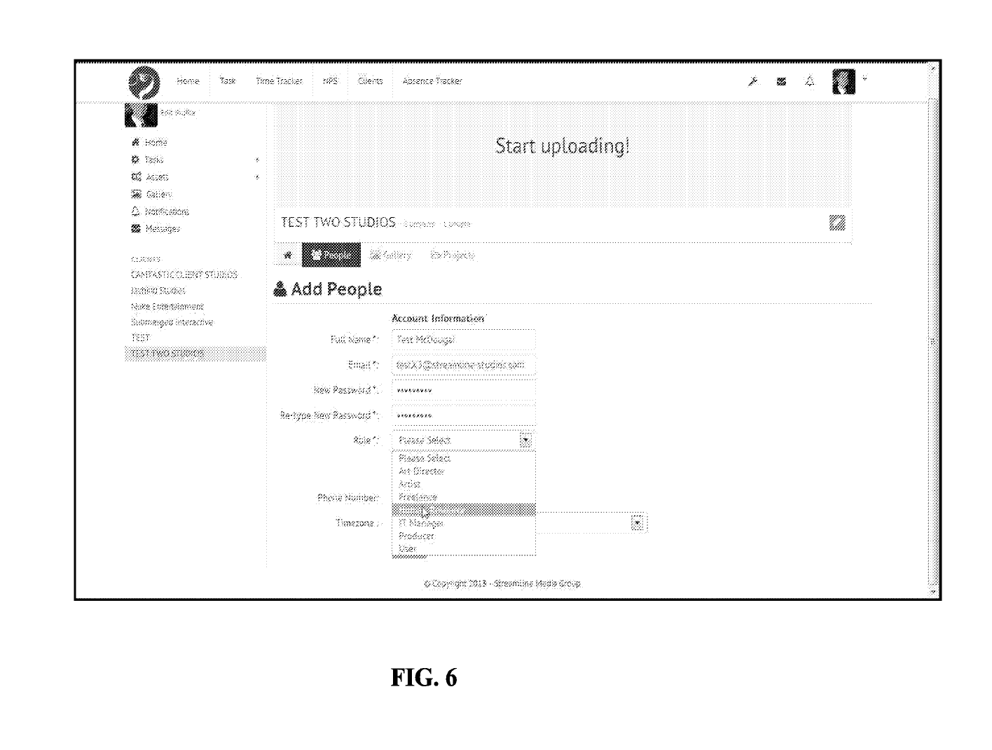

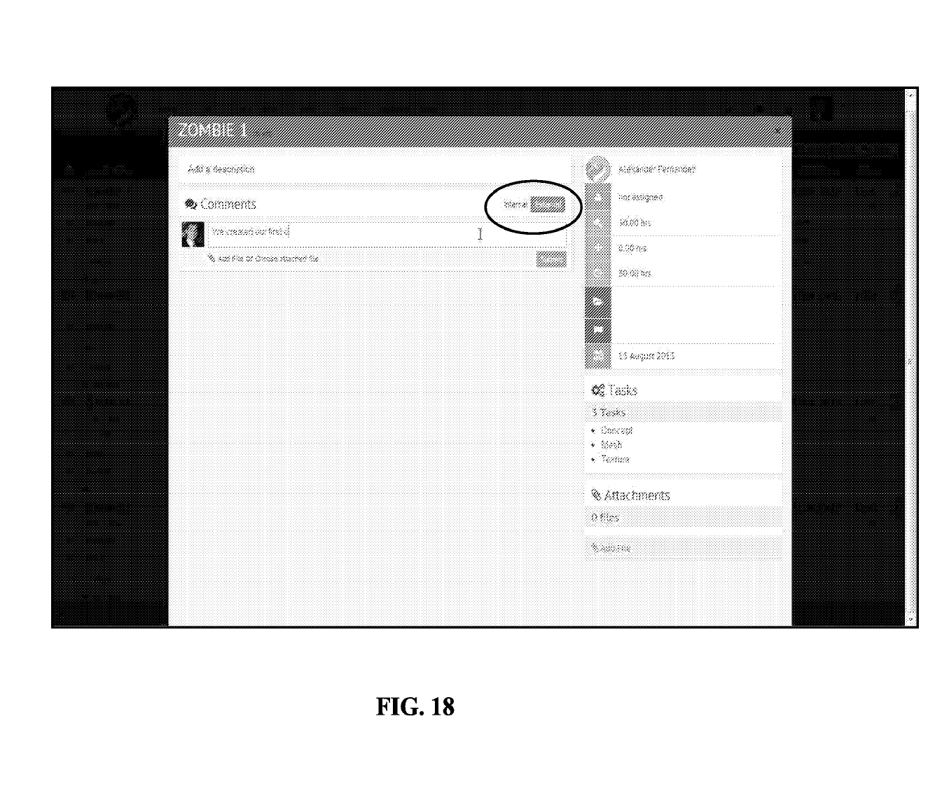

FIGS. 5-32 are illustrative screenshots of an exemplary implementation showing aspects of the herein described systems and methods. The screenshots are of an exemplary user interface running on a user terminal, in data communication with a server executing a project management software application. FIG. 5 is a screen for inputting information of a new client, and FIG. 6 is a screen for inputting information of a new client contact of the client. As shown, the client contact information includes credentials including a password to log into the system, and a list of predefined roles one of which may be selected and associated with the contact.

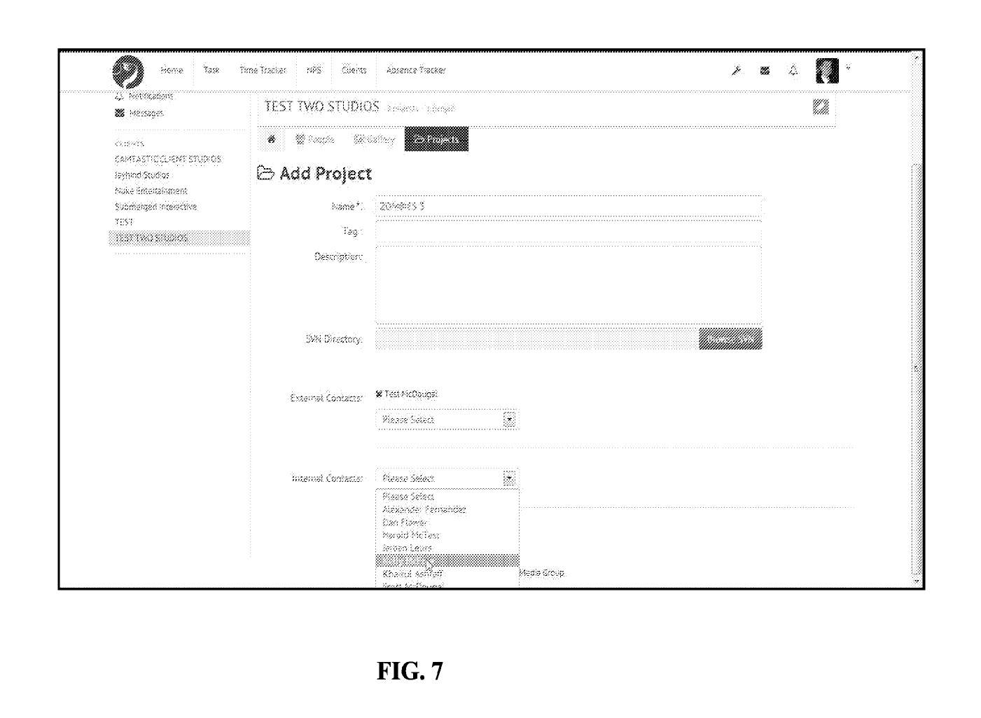

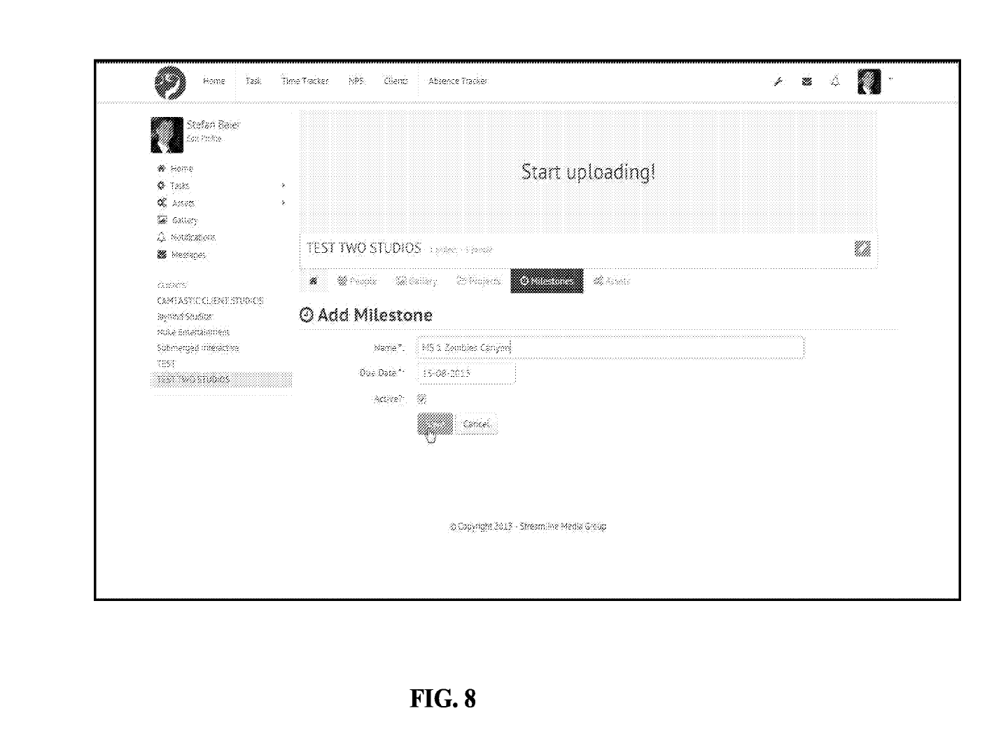

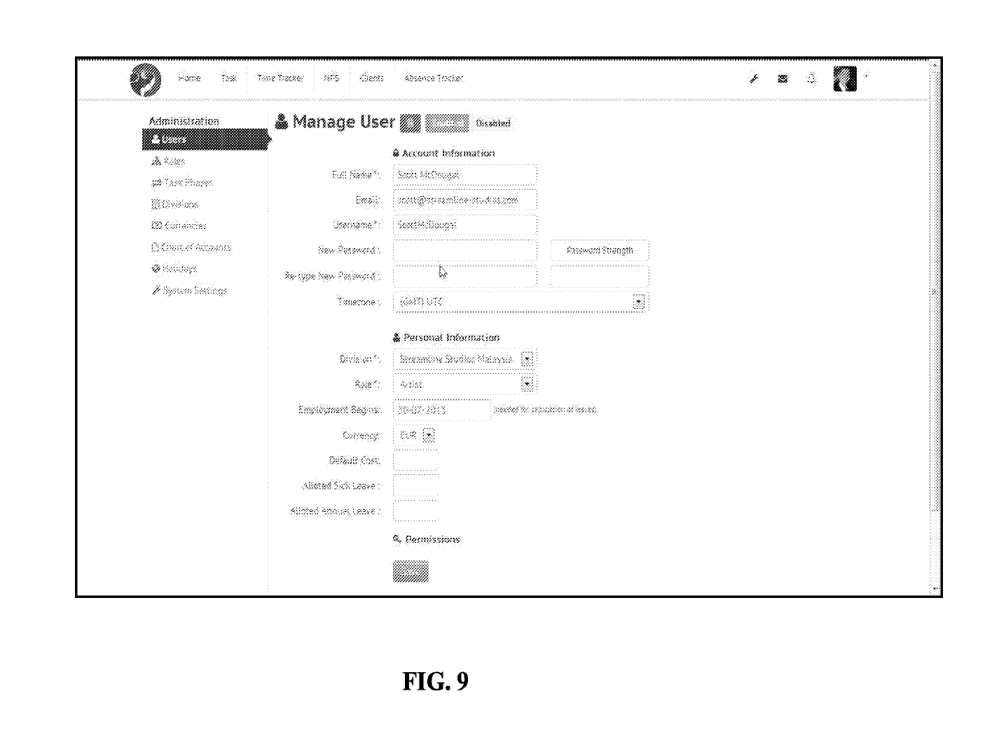

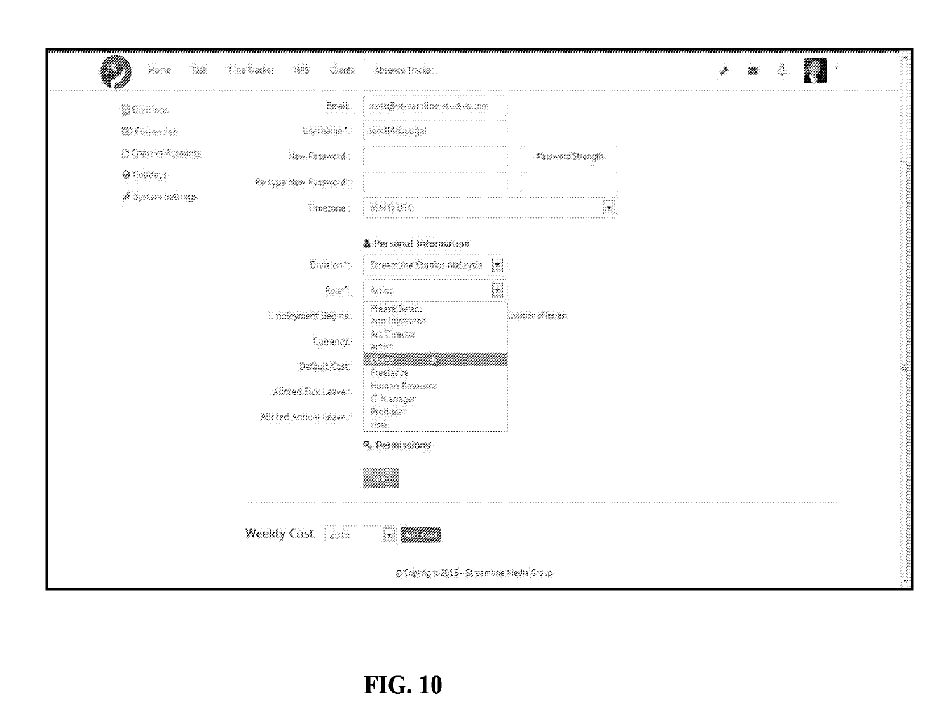

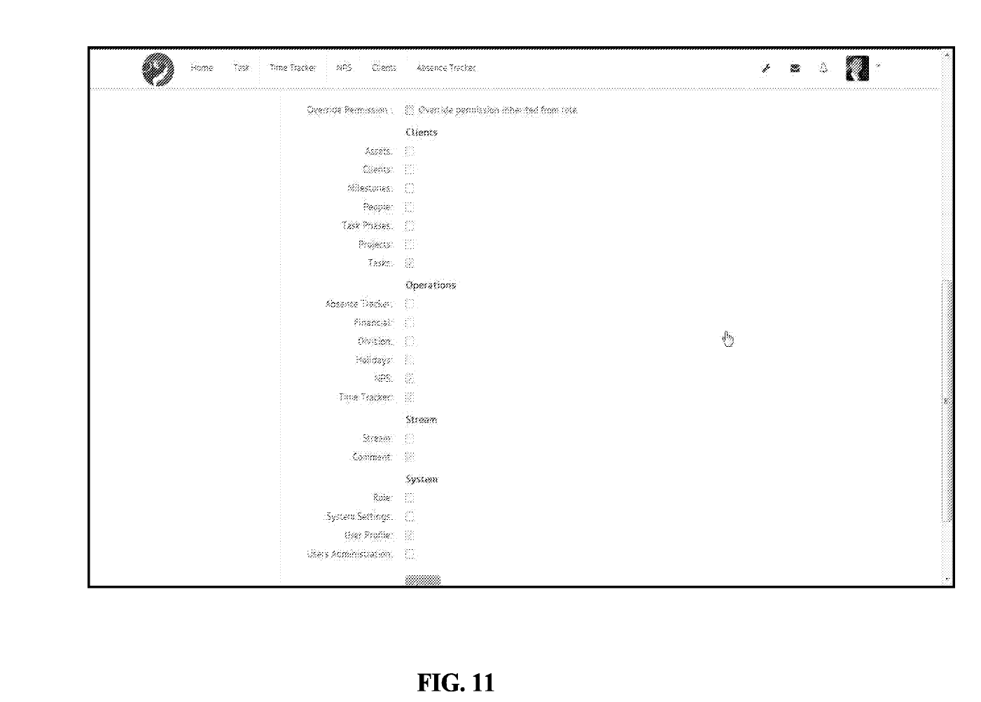

FIG. 7 is a screen for inputting information of a new project to be accomplished for the client. FIG. 8 is for inputting information defining a project milestone. FIG. 9 is for inputting information of an internal contact, such as a member of a team that will be working on the project, which includes more complete information than for client contacts. FIG. 10 shows a list of roles, one of which may be selected and associated with the internal contact, and FIG. 11 shows a list of permissions that may be assigned to the internal contact, thereby controlling the scope of operation of the system in connect with the internal contact. In an embodiment, the roles can be set up as templates that include appropriate permission selections.

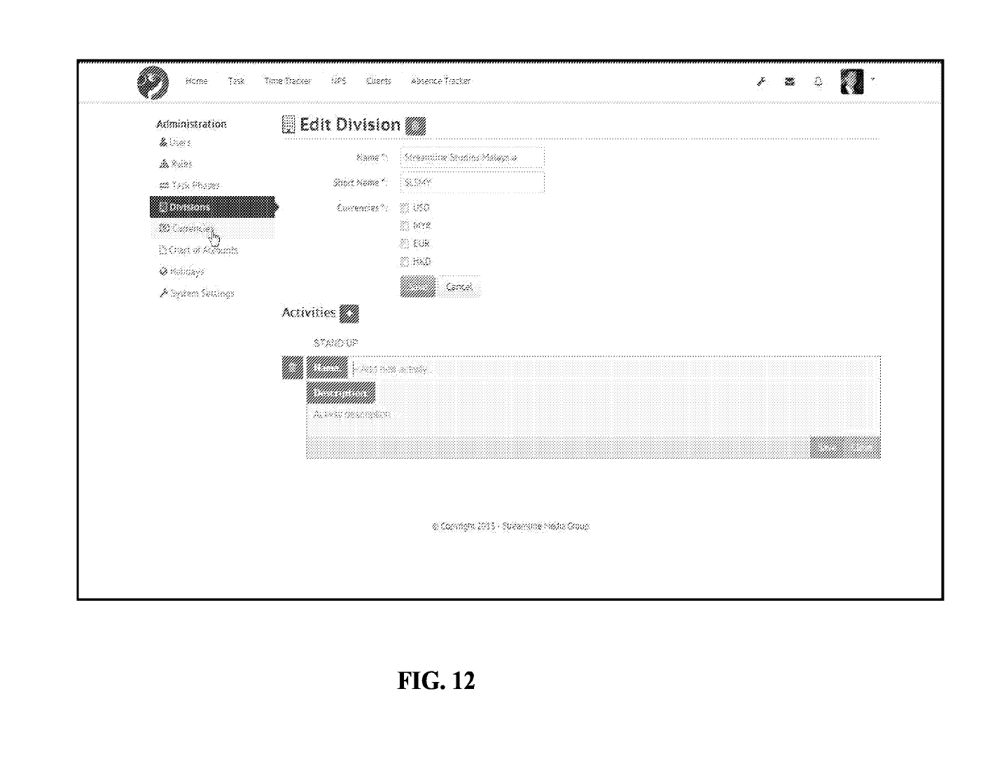

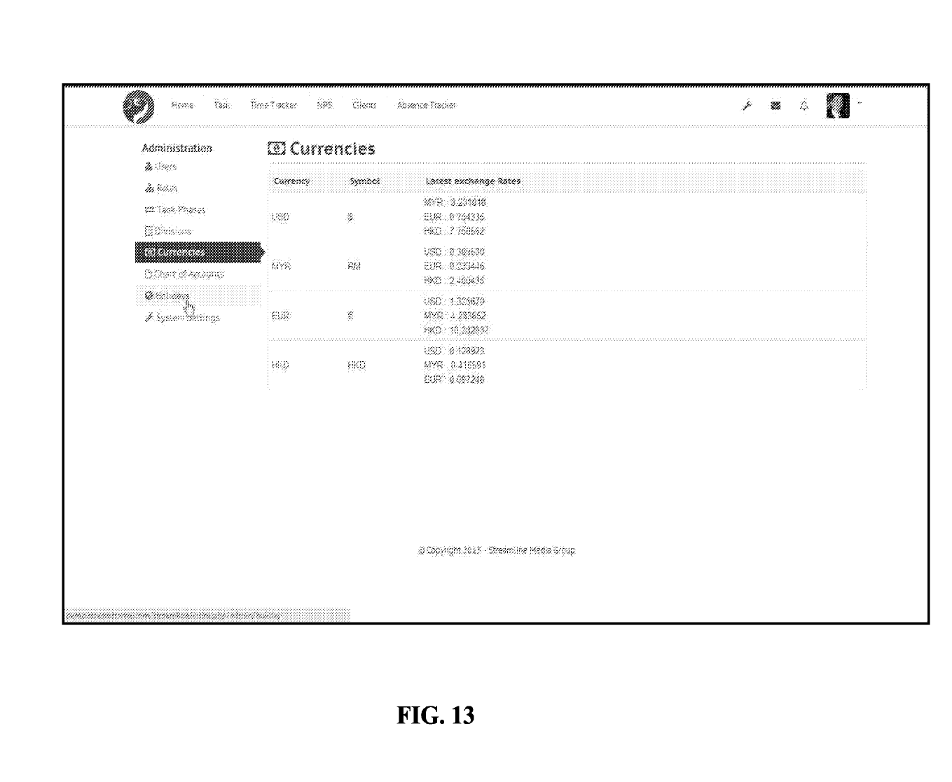

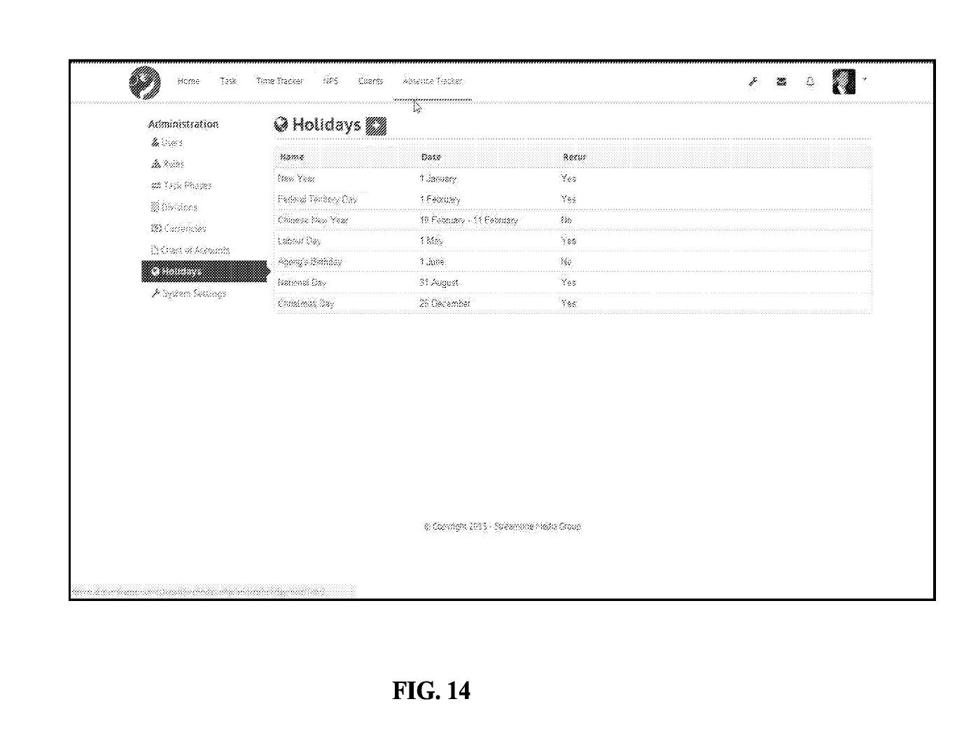

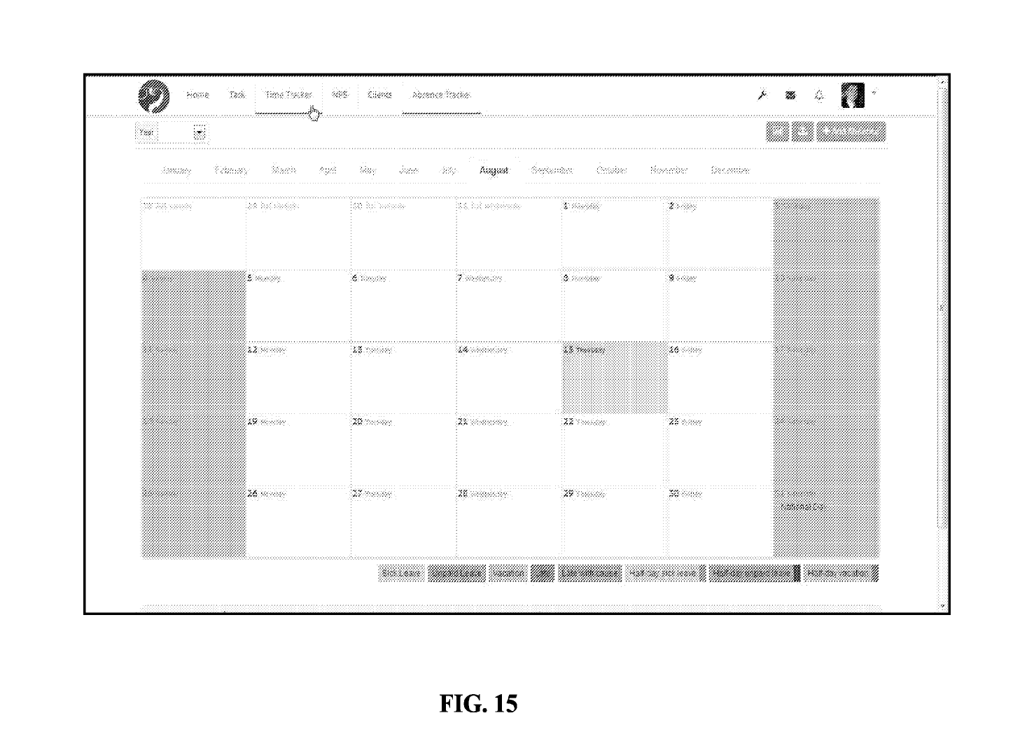

FIG. 12 is a screen for inputting information of internal organization divisions and activities associated with the divisions in connection with the project. FIG. 13 shows currencies that may be used in accounting for financial transactions of the project. FIG. 14 shows a holiday schedule that will affect the scheduling of team members to which they apply. FIG. 15 is a calendar view that may be used for scheduling, and that may interface with a human resources-related application, for example. Thus, in the illustrative implementation, a great deal of information may be included that will have an effect on project scheduling.

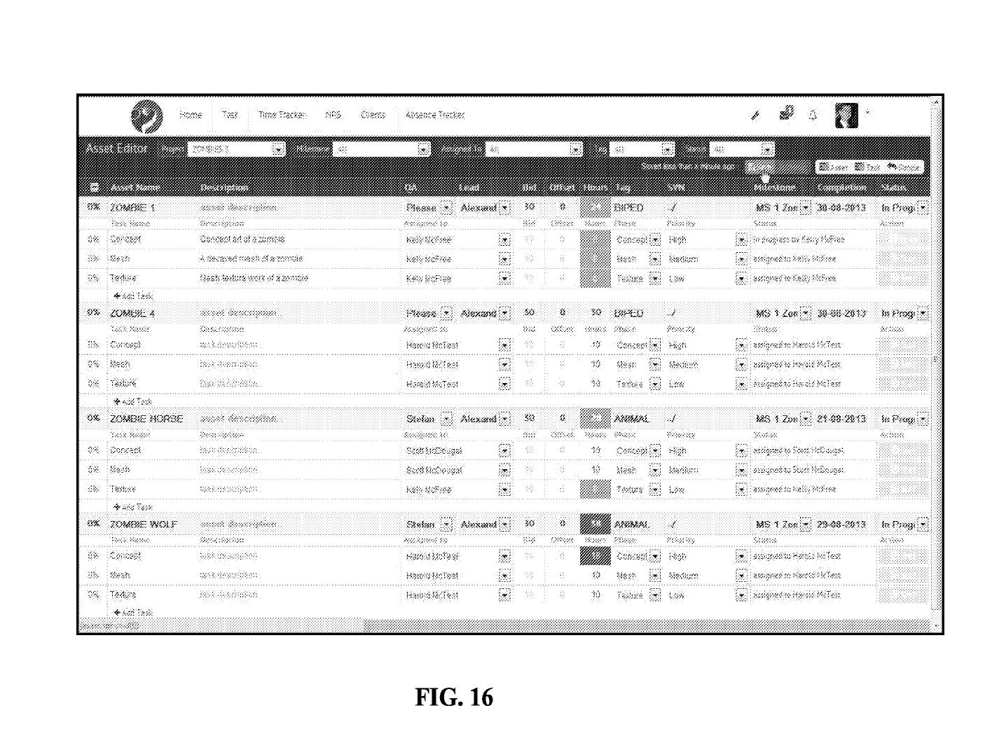

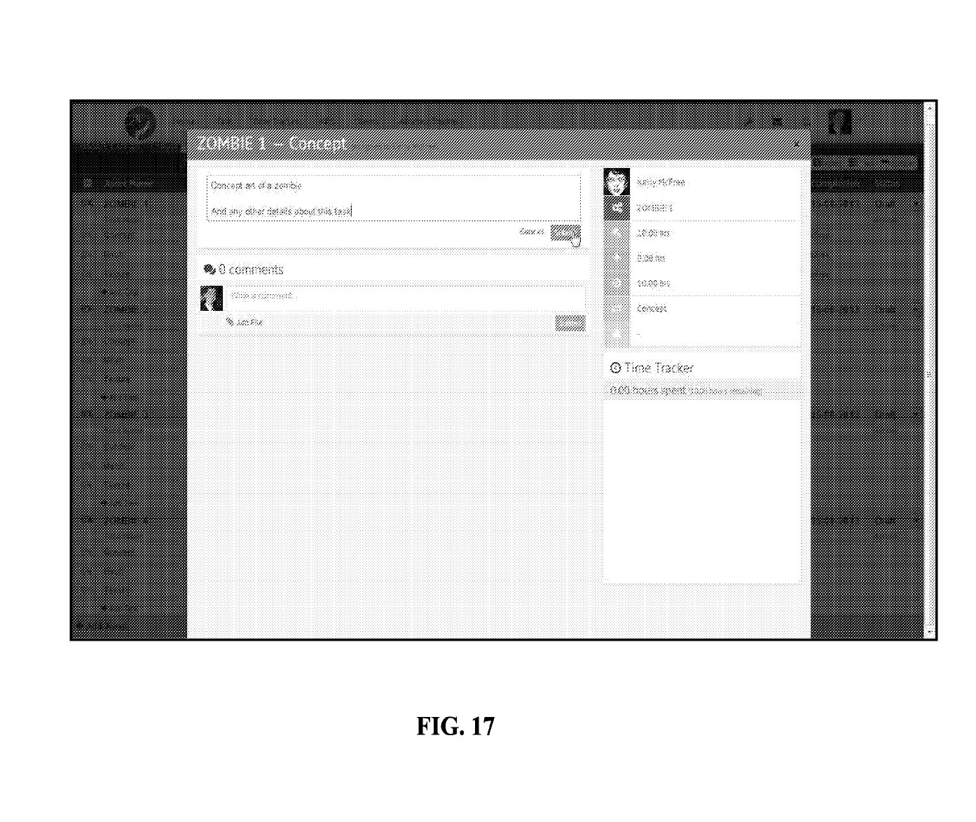

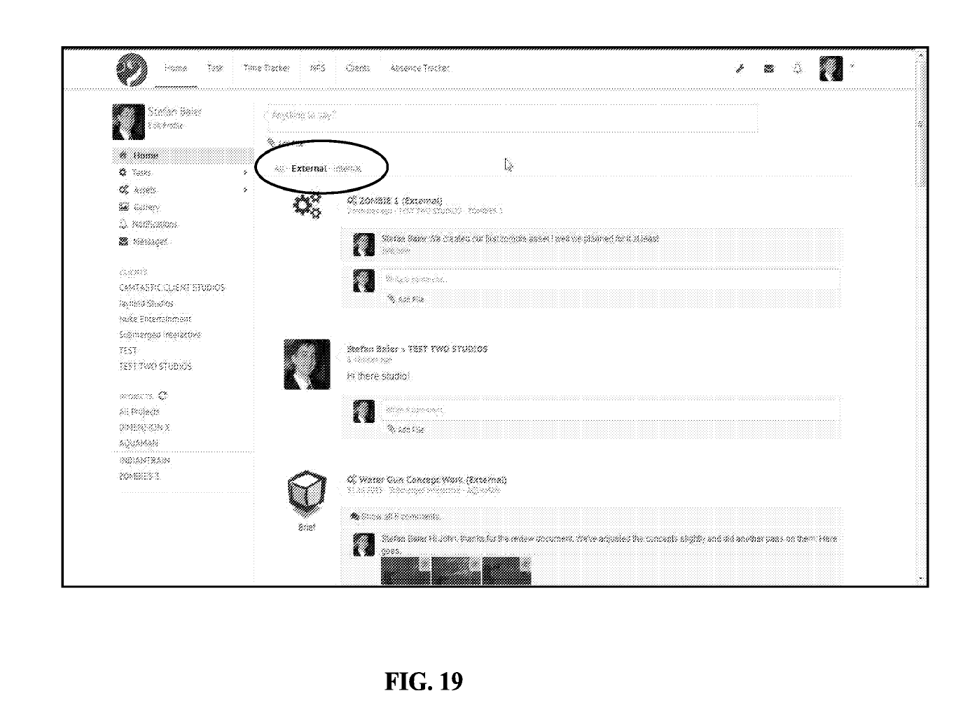

FIG. 16 is a screen for inputting information of an asset, such as a deliverable, that is included as part of the project. A project will commonly include within its scope a plurality of such assets. As shown, colors may be used to highlight certain aspects of tasks and assets. For example, as shown, where the hours estimated internally to be required to complete a task are less than a bid amount of an approved bid, the hours are highlighted in green. Conversely, hours estimated to exceed the bid amount may be highlighted in red, for example. FIG. 17 is a screen for adding details to an aspect of the assets of FIG. 16. The screen of FIG. 17 includes a switch to change the focus of the screen between what is viewable to internal users of the system, and what is viewable to external users. The feature of changing a focus or applying a filter to distinguish matter viewable to internal users versus external users may be implemented in various aspects of the system. For example, FIG. 19 shows a view of a “stream” of data objects that are tracked by the system, which may also be filtered according to internal versus external users. In general, the internally viewable subject matter is useful for internal users to obtain an accurate understanding of the actual status of various details of a project. In contrast, the externally viewable subject matter is controlled to control the perception of various aspects of the project and the project as a whole to external users. Thus, the external views may be automatically filtered, summarized, and/or abstracted, such as to convey realistic expectations to a client without overwhelming them with too much detail, or internal aspects that would be of no interest to the client.

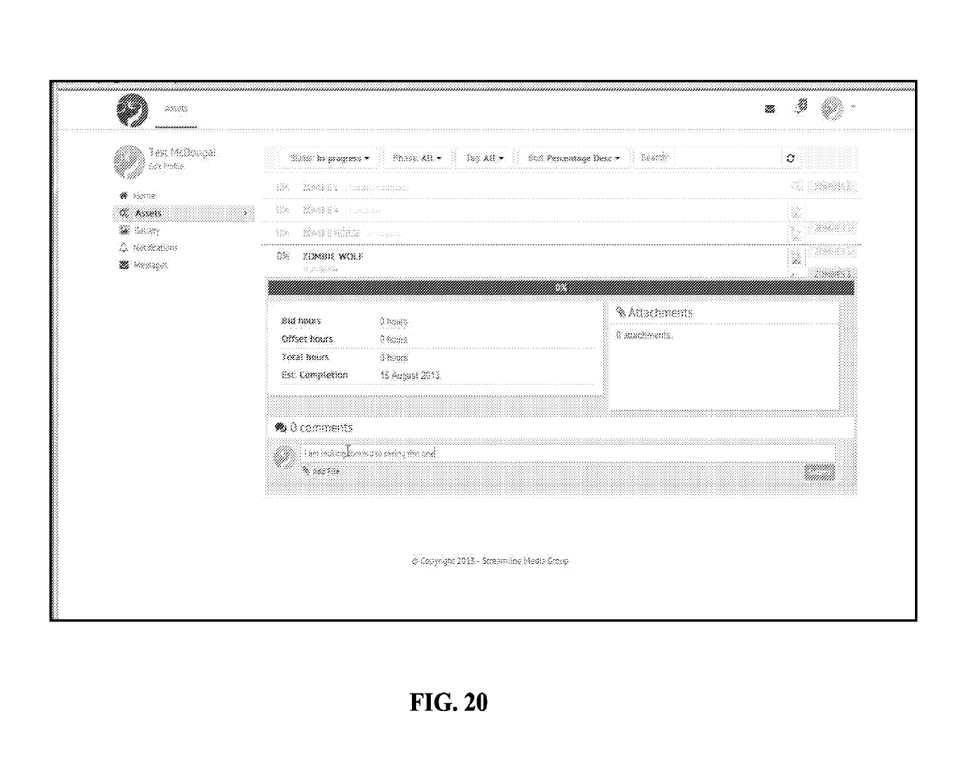

In an embodiment, external users may be exposed to project level information, asset level information, and certain agreed-upon constraints such as a number of person-hours that may be charged to a project of asset. In contrast, the more detailed task-related aspects that are of no interest to external users may not be exposed to them. For example, FIG. 20 is a screen showing an external view of the assets that were shown being set up in FIG. 16. None of the task level detail is exposed externally, rather, only asset level information is shown, with one of the assets selected to show asset level information that may be of interest to a client, for example. In addition, a messaging mechanism is included in the illustrative application that can be used to exchange messages with clients, obtain approvals, and the like.

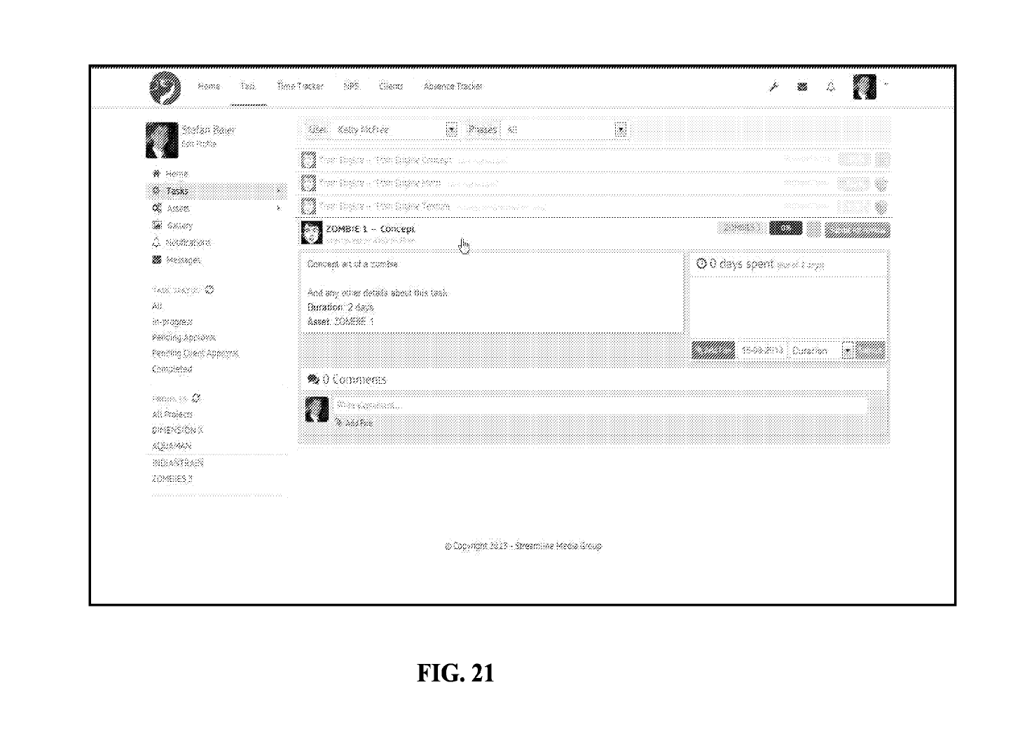

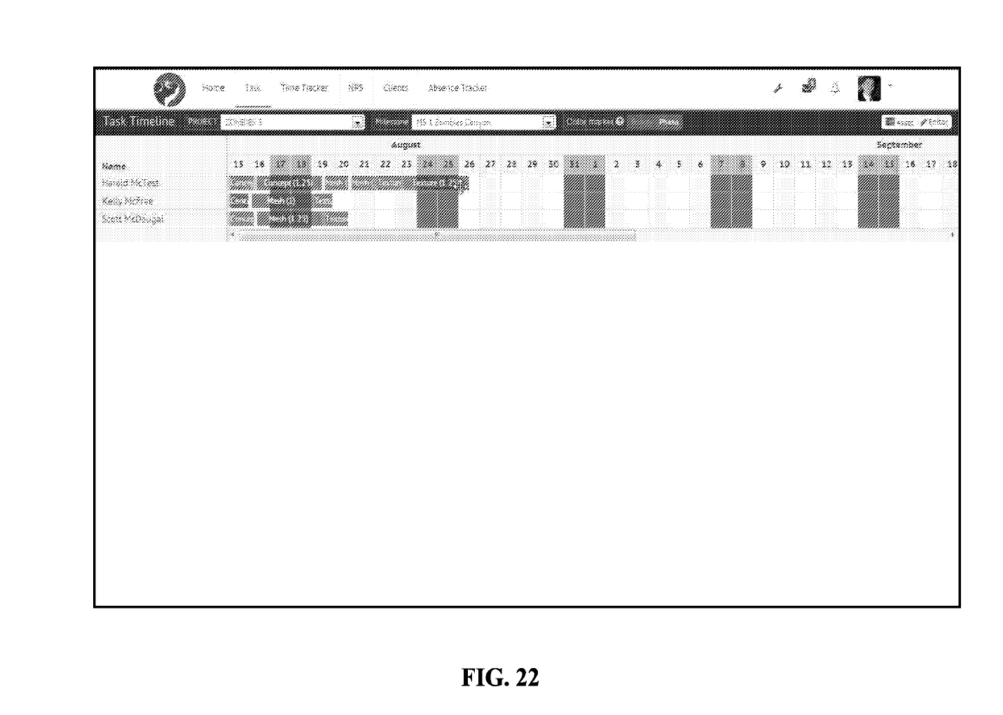

FIG. 21 is a screen showing a list of tasks that have been assigned to a worker working on the project, showing detail of a select task. FIG. 22 is a timeline showing the time scheduled to be spent on the assets shown in FIG. 16. In an embodiment, the timeline is generated by the system based on the workers to whom tasks of each asset have been assigned and the priorities that have been assigned to the tasks.

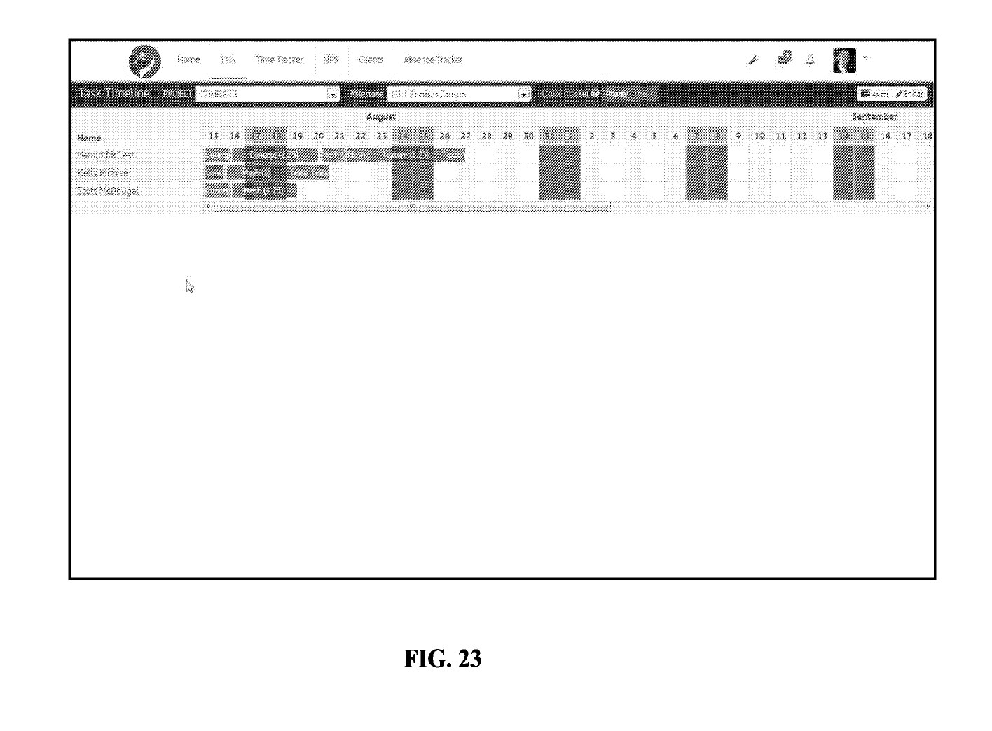

FIG. 23 shows the timeline being filtered to show a select subset, such as tasks of a select type, although other bases may be used such as tasks of a select priority, or according to tags that have been applied to tasks.

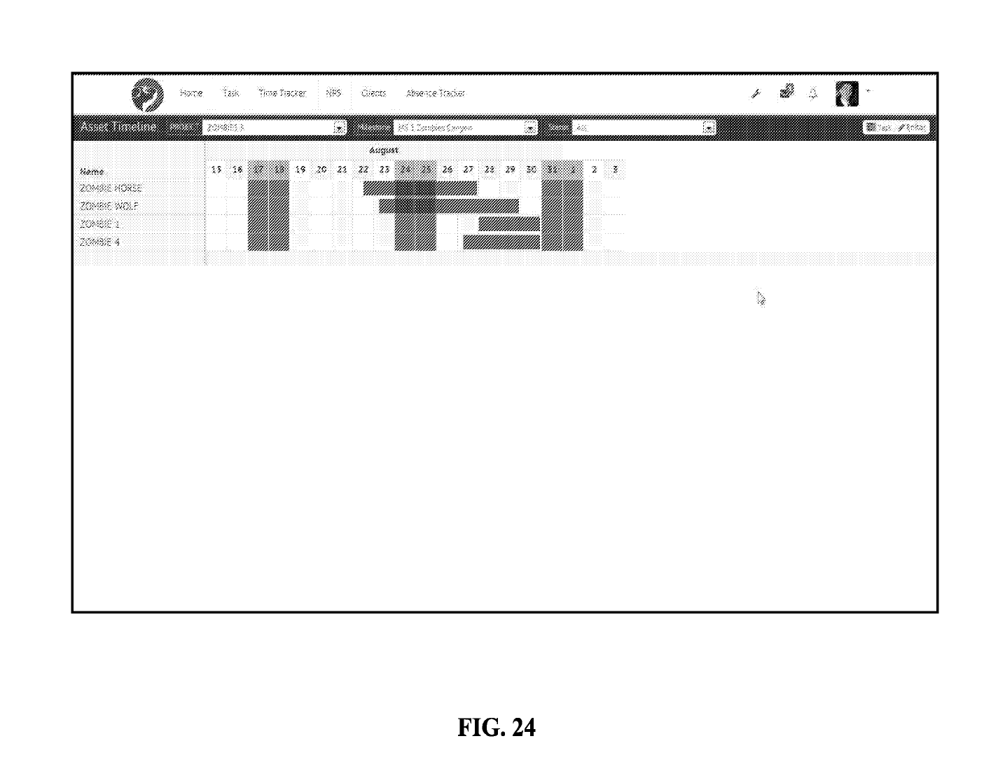

FIG. 24 shows an asset timeline formatted for external viewing. As shown, this timeline does not display information more detailed than the asset level.

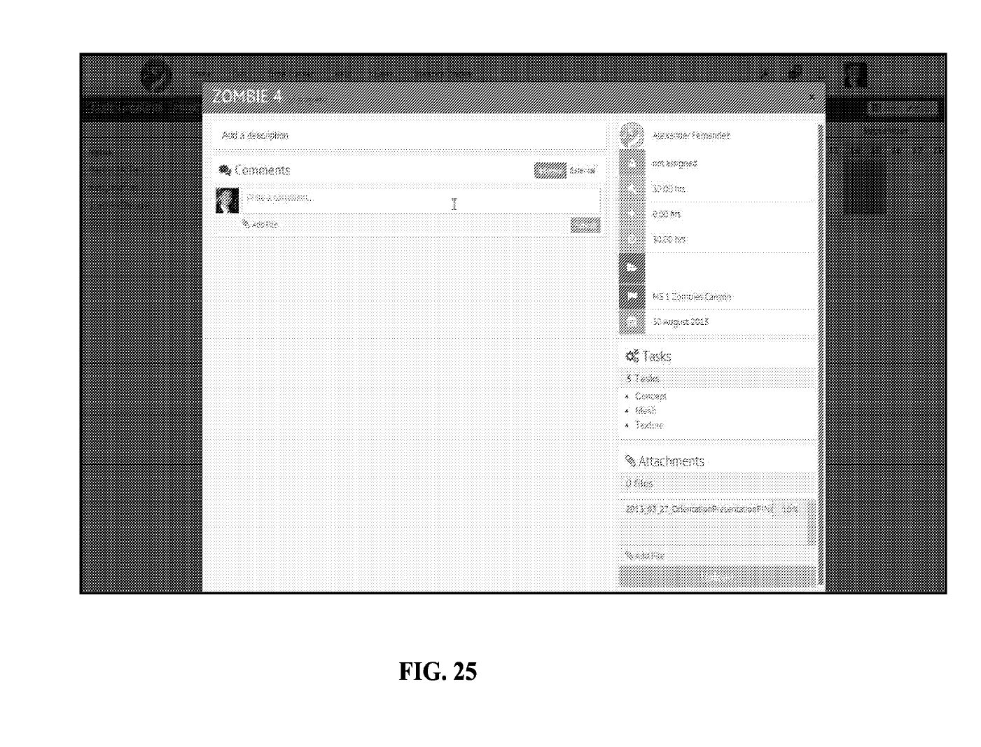

FIG. 25 shows detail of an asset selected by an internal user. As shown, task information may be displayed internally but not externally, whereas asset level information may be entered and files uploaded to the server for external viewing.

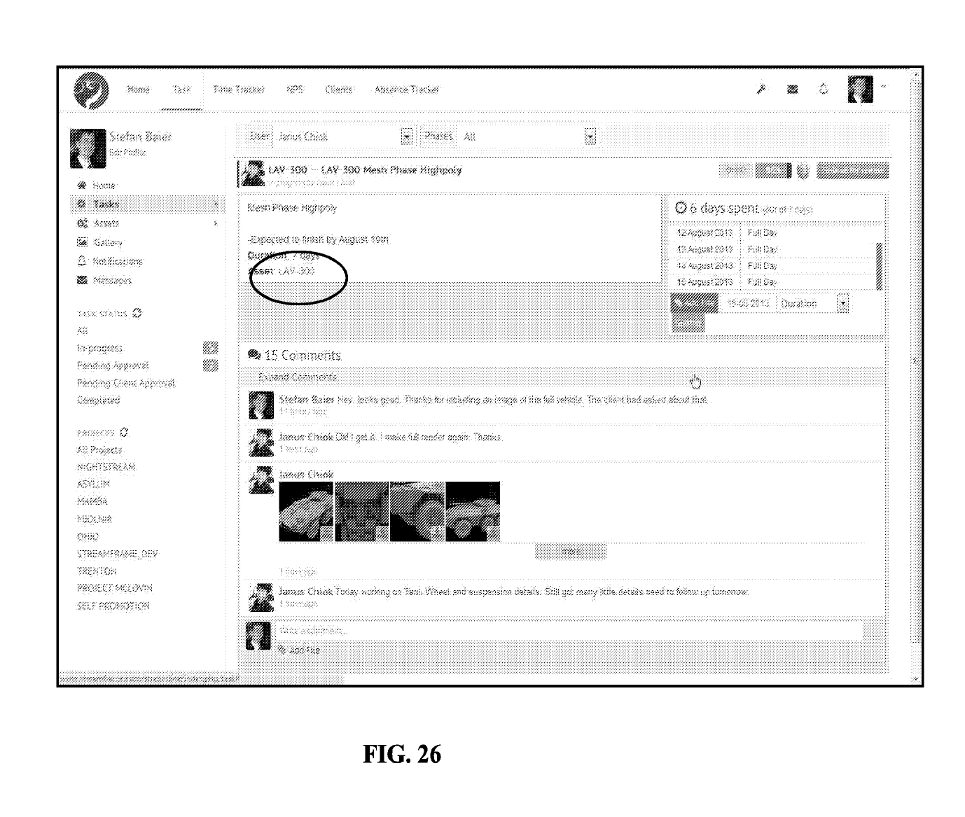

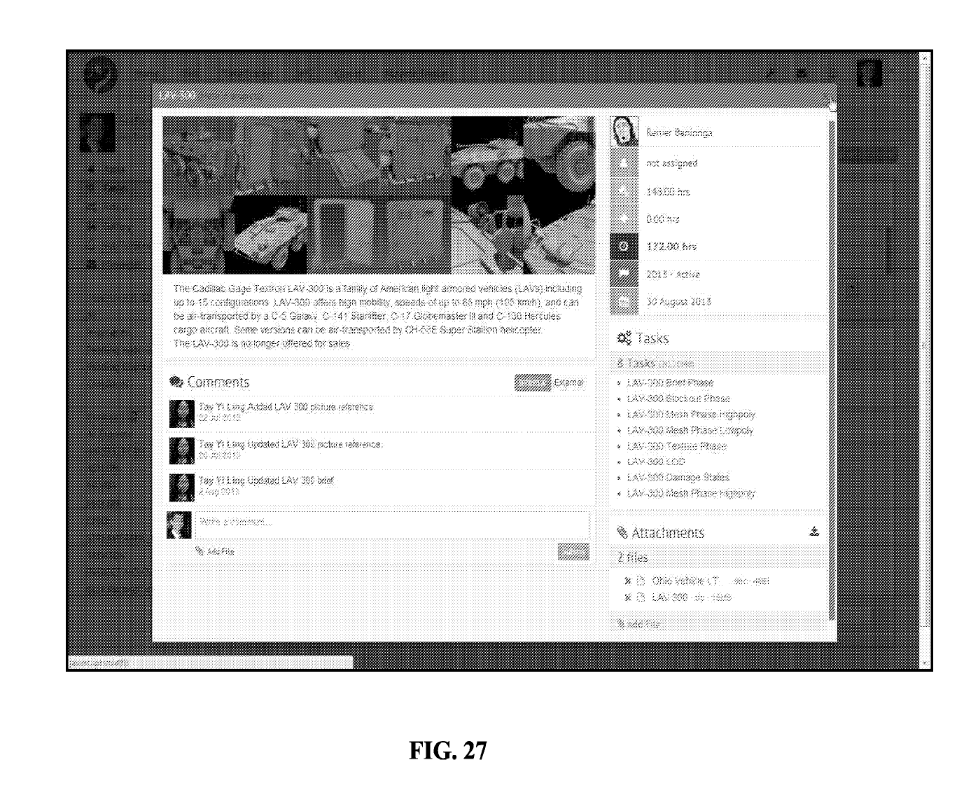

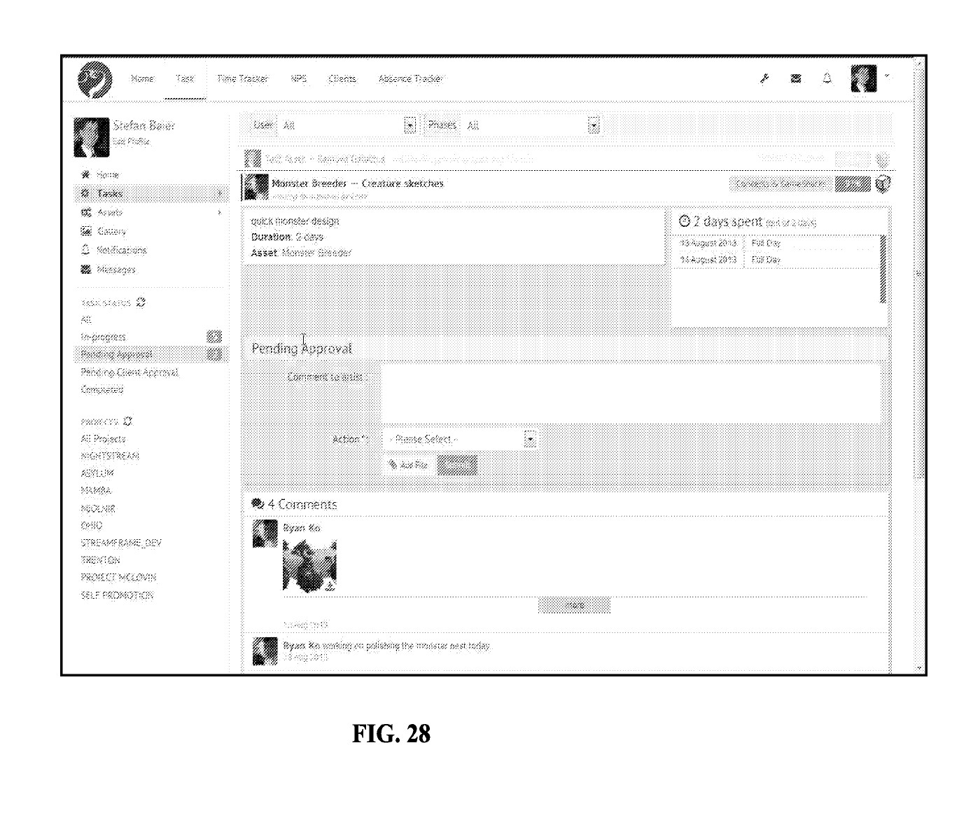

FIG. 26 shows a screen containing information pertaining to a select internal worker, that may be available to authorized users such as managers. FIG. 27 shows even more detail of an asset selected from a link circled in FIG. 26. FIG. 28 shows a list of assets awaiting approval by a manager.

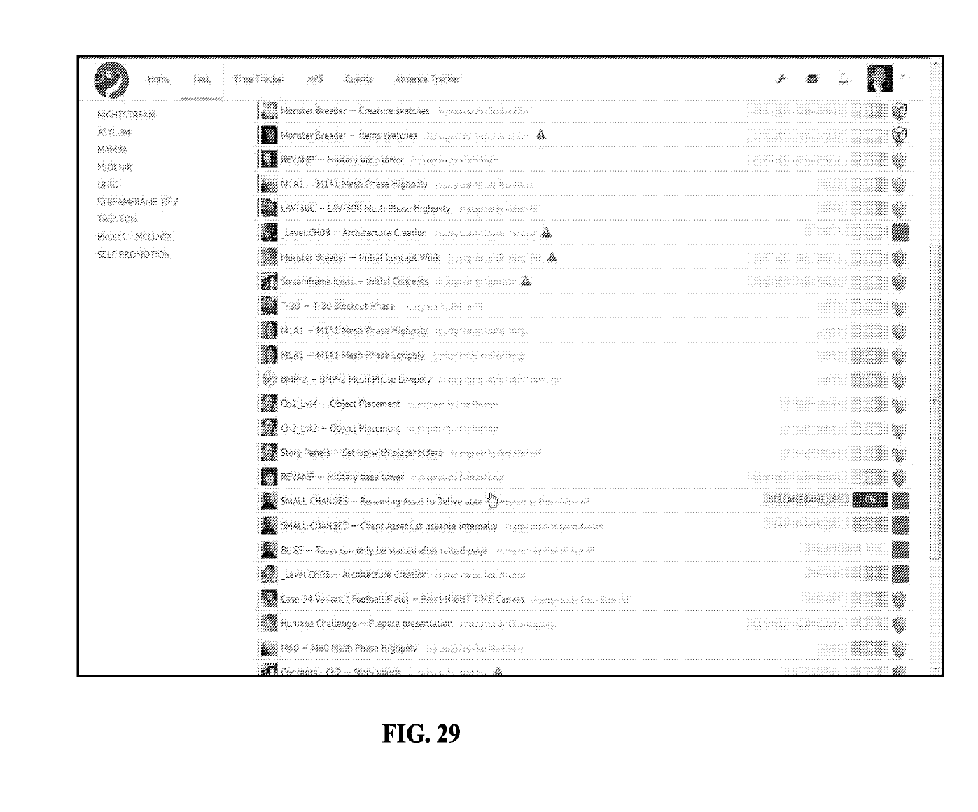

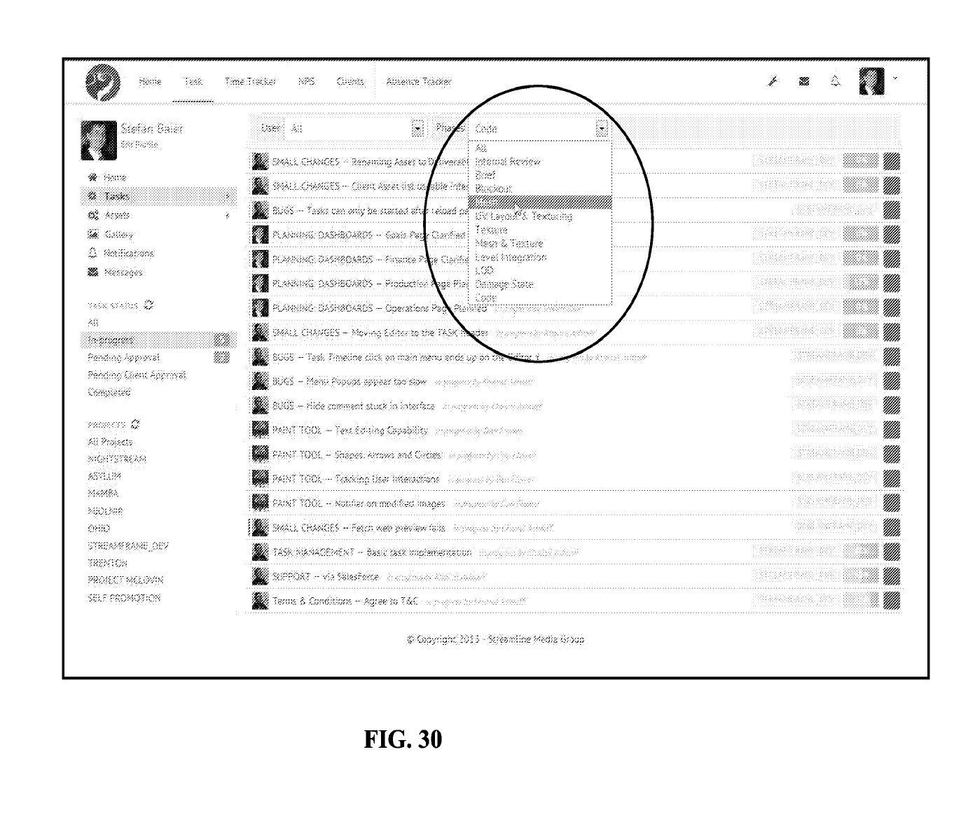

FIG. 29 shows a list of assets associated with a plurality of different projects, including responsible workers, status updates, progress indicators, and identifiers (here, an exclamation point in a triangle) where hours exceed the bid amount. FIG. 30 shows the list of FIG. 29 filtered by a criterion selected from a list of available criteria.

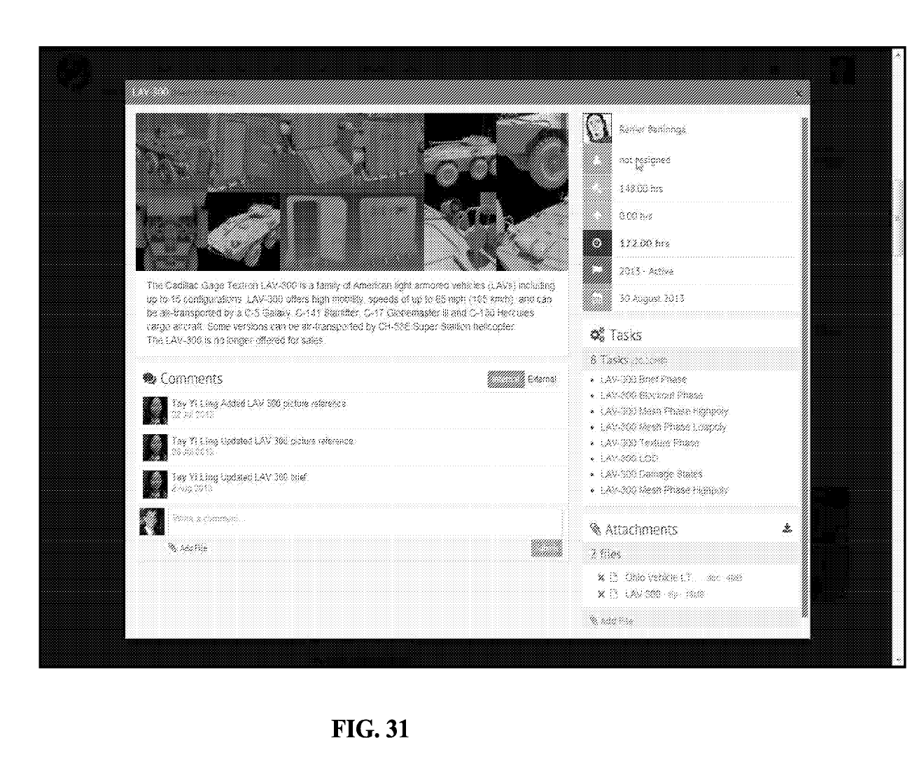

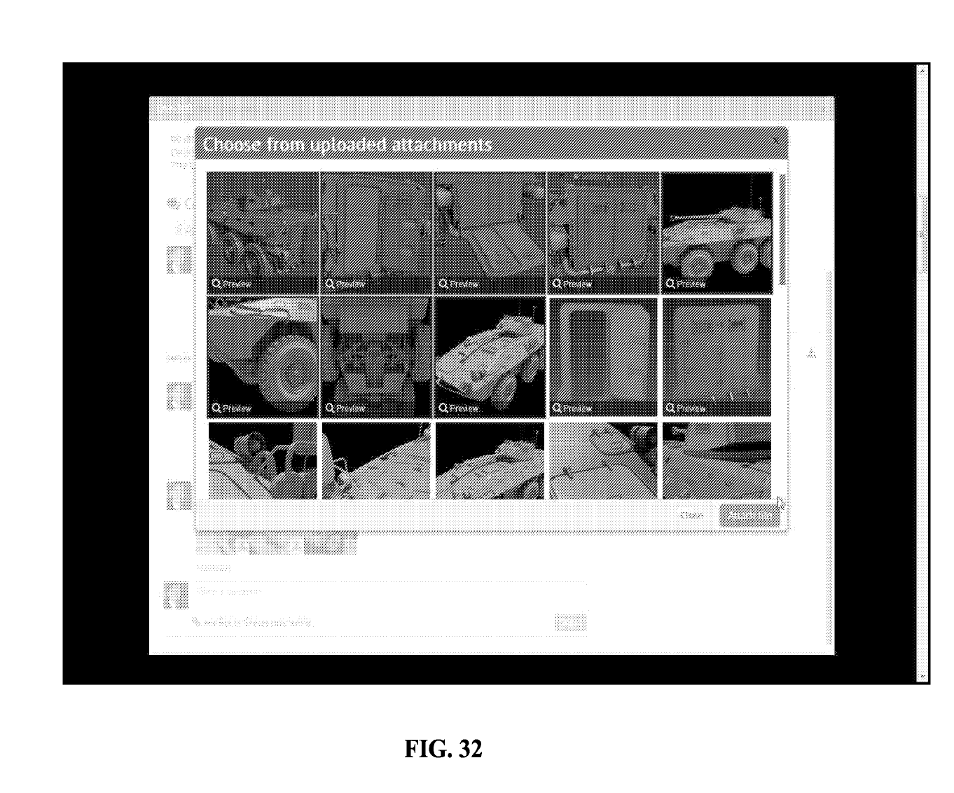

FIG. 31 is a screen showing details of a select asset. FIG. 32 shows an internal worker selecting images for uploading to the server. Because the images are asset-level information which can be accessed externally, they will be available for viewing externally. The system gathers in one place and makes available for selection images of files from all workers who may be working on the asset, simplifying the process of selecting files of an asset for sharing with clients.

Although the herein disclosed systems and methods have been described and illustrated in exemplary forms with a certain degree of particularity, it is noted that the description and illustrations have been made by way of example only. Numerous changes in the details of construction and combination and arrangement of parts and steps may be made, as will be apparent to those of ordinary skill in the pertinent arts in view of the disclosure herein. Accordingly, any such changes are intended to be included within the scope the invention, as defined by the claims appended hereto.

What is claimed is:

1. A system for managing projects, comprising:
a server having a tangible processor in data communication with a network interface that couples the server to a data communication network, the server processor further in data communication with a data storage device storing instructions which, when executed on the processor, cause the server to perform a method including:
obtaining information of a project to be completed, including an agreed upon quantity of a resource to be used to complete the project;
obtaining information of a plurality of related tasks to be accomplished to complete the project, including a priority of each task;
obtaining an estimate of the resource to be used to complete each of the tasks, and calculating a sum of the estimates as a total internal resource estimate;
obtaining a measure of the resource already consumed toward completion of each of the tasks, and calculating a sum of the measures as an actual internal quantity of the resource consumed;
obtaining a schedule for completing each of the tasks;
formatting for presentation to an internal user in accordance with internal formatting rules at least a portion of each of:
the information of the project;
the information of the tasks;
the information of the resources; and
the schedule; and
formatting for presentation to an external viewer in accordance with external formatting rules at least a portion of each of:
the information of the project; and
the schedule;
wherein the external formatting rules include:
generating a normalization factor based on a comparison of the agreed upon quantity of the resource to the total internal resource estimate;
multiplying the actual internal quantity of the resource by the normalization factor to form a project progress indicator; and
presenting the asset progress indicator on a display device.

2. The system of claim 1, wherein the data storage device stores instructions that cause the server to perform a method that further comprises:
obtaining information of a plurality of assets to be created as part of the project, including an agreed upon quantity of the resource to be used to complete each asset;
associating a portion of the tasks with each respective asset;
calculating a sum of the estimates of the resource to be used to complete the tasks associated with each asset as an internal resource estimate of the asset;
calculating, from the measure of the resource already consumed toward completion of each of the tasks, a sum of the measures of the resource already consumed toward completion of each of the assets as an actual internal resource quantity of the asset;
wherein:
the formatting for presentation to an internal viewer includes at least a portion of the actual internal resource quantity associated with at least a portion of the assets; and
the external formatting rules include:
generating a normalization factor based on a comparison of the agreed upon quantity of the resource to be used to complete each asset to the internal resource estimate of the asset;
multiplying the actual internal resource quantity of the resource associated with respective assets by the respective normalization factor to form an asset progress indicator; and
presenting the asset progress indicator on the display device.

3. The system of claim 1, wherein the resource comprises work hours associated with workers.

4. The system of claim 3, wherein the data storage device stores instructions that cause the server to perform a method that further comprises:
obtaining an assignment of the tasks to respective workers;
generating a timeline representative of the respective worker hours associated with each task;
obtaining a measure of actual worker hours spent on respective tasks; and
updating the timeline and revising the schedule.

5. The system of claim 4, wherein the data storage device stores instructions that cause the server to perform a method that further comprises:
obtaining a role of at least one of the workers representative of a domain of responsibility of the worker;
wherein the internal formatting rules include at least one rule for presenting information to an internal user based on the role of the worker.

6. The system of claim 4, wherein the data storage device stores instructions that cause the server to perform a method that further comprises:
obtaining information of a new task including a priority of the task and an assignment of the task to a select worker for completion; and
revising the schedule including rearranging the tasks to insert the new task into the schedule before tasks having a lower priority than the new task.

7. The system of claim 6, wherein the data storage device stores instructions that cause the server to perform a method that further comprises:
generating a fragmentation index associated with the select worker representative of at least one of a number of gaps in the worker's schedule, a duration of each respective gap, and a measure of the contiguous time in the schedule for each task;
wherein the revising the schedule includes rearranging the tasks to reduce the fragmentation index of the worker.

8. The system of claim 3, wherein the data storage device stores instructions that cause the server to perform a method that further comprises:
obtaining an hourly rate of each respective worker; and
generating, using the hourly rates, a value of at least one of the time actually spent on an asset, the internal resource estimate of the asset, the time actually spent on the project, and the internal resource estimate of the project.

9. The system of claim 8, wherein the data storage device stores instructions that cause the server to perform a method that further comprises:
generating, using the hourly rates, at least one of an accrued profit associated with an asset, an estimate of the total profit associated with the asset, an accrued profit associated with the project, and an estimate of the total profit associated with the project.

10. A computer-based method for managing projects, comprising:
obtaining at a server:
information of a project to be completed, including an agreed upon quantity of a resource to be used to complete the project;
information of a plurality of related tasks to be accomplished to complete the project, including a priority of each task;
an estimate of the resource to be used to complete each of the tasks, and calculating a sum of the estimates as a total internal resource estimate;
a measure of the resource already consumed toward completion of each of the tasks, and calculating a sum of the measures as an actual internal quantity of the resource consumed; and
a schedule for completing each of the tasks;
formatting by the server for presentation to an internal user in accordance with internal formatting rules at least a portion of each of:
the information of the project;
the information of the tasks;
the information of the resources; and
the schedule; and
formatting by the server for presentation to an external viewer in accordance with external formatting rules at least a portion of each of:
the information of the project; and
the schedule;
wherein the external formatting rules include:
generating a normalization factor based on a comparison of the agreed upon quantity of the resource to the total internal resource estimate;
multiplying the actual internal quantity of the resource by the normalization factor to form a project progress indicator; and
presenting the asset progress indicator on a display device.

11. The method of claim 10, further comprising:
obtaining information of a plurality of assets to be created as part of the project, including an agreed upon quantity of the resource to be used to complete each asset;
associating a portion of the tasks with each respective asset;
calculating a sum of the estimates of the resource to be used to complete the tasks associated with each asset as an internal resource estimate of the asset;
calculating, from the measure of the resource already consumed toward completion of each of the tasks, a sum of the measures of the resource already consumed toward completion of each of the assets as an actual internal resource quantity of the asset;
wherein:
the formatting for presentation to an internal viewer includes at least a portion of the actual internal resource quantity associated with at least a portion of the assets; and
the external formatting rules include:
generating a normalization factor based on a comparison of the agreed upon quantity of the resource to be used to complete each asset to the internal resource estimate of the asset;
multiplying the actual internal resource quantity of the resource associated with respective assets by the respective normalization factor to form an asset progress indicator; and
presenting the asset progress indicator on the display device.

12. The method of claim 10, wherein the resource comprises work hours associated with workers.

13. The method of claim 12, further comprising:
obtaining an assignment of the tasks to respective workers;
generating a timeline representative of the respective worker hours associated with each task;
obtaining a measure of actual worker hours spent on respective tasks; and
updating the timeline and revising the schedule.

14. The method of claim 13, further comprising:
obtaining a role of at least one of the workers representative of a domain of responsibility of the worker;
wherein the internal formatting rules include at least one rule for presenting information to an internal user based on the role of the worker.

15. The method of claim 13, further comprising:
obtaining information of a new task including a priority of the task and an assignment of the task to a select worker for completion; and
revising the schedule including rearranging the tasks to insert the new task into the schedule before tasks having a lower priority than the new task.

16. The method of claim 15, further comprising:
generating a fragmentation index associated with the select worker representative of at least one of a number of gaps in the worker's schedule, a duration of each respective gap, and a measure of the contiguous time in the schedule for each task;
wherein the revising the schedule includes rearranging the tasks to reduce the fragmentation index of the worker.

17. The method of claim 12, further comprising:
obtaining an hourly rate of each respective worker; and
generating, using the hourly rates, a value of at least one of the time actually spent on an asset, the internal resource estimate of the asset, the time actually spent on the project, and the internal resource estimate of the project.

18. The method of claim 17, further comprising:
generating, using the hourly rates, at least one of an accrued profit associated with an asset, an estimate of the total profit associated with the asset, an accrued profit associated with the project, and an estimate of the total profit associated with the project.

19. A computer-based method for managing projects, comprising:
exchanging:
information of a project to be completed, including an agreed upon quantity of a resource to be used to complete the project;
information of a plurality of related tasks to be accomplished to complete the project, including a priority of each task;
an estimate of the resource to be used to complete each of the tasks, and calculating a sum of the estimates as a total internal resource estimate;
at least two measures of the resource already consumed toward completion of each of the tasks, and calculating a sum of the measures as an actual internal quantity of the resource consumed; and
a schedule for completing each of the tasks;
formatting the project, the tasks, the resources, and the schedule; and
presenting to an external viewer the information of the project and the schedule.
